(19) United States
(12) Patent Application Publication
(10) Pub. No.: US 2026/0358297 A1
(43) Pub. Date: Nov. 12, 2026

(54) DAMAGE DETECTION FRAMEWORK TO DETECT RAIL DEFECTS USING LASER DOPPLER VIBROMETER MEASUREMENTS COLLECTED FROM A MOVING PLATFORM

(71) Applicant: BOARD OF REGENTS, THE UNIVERSITY OF TEXAS SYSTEM, Austin, TX (US)

(72) Inventors: Salvatore Salamone, Austin, TX (US); Korkut Kaynardag, Austin, TX (US); Chi Yang, Austin, TX (US)

(21) Appl. No.: 19/184,364

(22) Filed: Apr. 21, 2025

Related U.S. Application Data
(60) Provisional application No. 63/636,717, filed on Apr. 20, 2024.

(51) Int. Cl. G01N 29/04; G01H 9/00; G01N 29/265; G01N 29/38; G01N 29/44

(52) U.S. Cl. CPC G01N 29/045; G01H 9/00; G01N 29/265; G01N 29/38; G01N 29/4445; G01N 29/4481

(57) ABSTRACT

A system includes a laser Doppler vibrometer sensor assembly mounted to a moving mobile defect detection platform having one or more excitation mechanisms to cause impact forces on a railway track and generate transverse waves therein. The laser Doppler vibrometer sensor assembly senses and measures vibration measurements caused by the excitation mechanism. A coupling member mounts one or more laser doppler vibrometer sensors to a portion of the mobile defect detection platform. The vibration measurements are processed by one or more filters to (i) remove speckle noise caused by movement of the laser Doppler vibrometer sensor assembly along the railway track and (ii) correct distorted portions of the vibration measurements caused by impulses from train wheels of the mobile defect detection platform to generate a filtered vibration measurement. The filtered vibration measurements are analyzed to determine one or more defects in the railway track.

### CROSS-REFERENCE TO RELATED APPLICATIONS

This application claims priority to and the benefit of U.S. Provisional Patent Application No. 63/636,717, filed Apr. 20, 2024, the entire contents of which are incorporated herein by reference.

### GOVERNMENT LICENSES RIGHTS

This invention was made with government support under Contract No. 693JJ619C000005 awarded by the Federal Railroad Administration. The government has certain rights in the invention.

### BACKGROUND

Railroads play a vital role in the safety, prosperity, and well-being of our communities and businesses. However, due to increases in train speeds and axle loads that are being applied to aging and deteriorating railroad tracks, the occurrence of rail defects becomes of increasing concern for railroad owners and regulators. Transverse defects located inside rail head is one of the very hazardous rail defects since they can lead to rail breaks when their size reaches a critical level.

Nondestructive evaluation (NDE) technology has been previously evaluated to detect transverse defects in rails using ultrasonic testing in which an array of piezoelectric transducers stationed at different angles in liquid-filled wheels or sleds are used in a pulse-echo configuration. However, the existence of surface defects such as shelling might cause challenges for such systems since they can obstruct the propagation of ultrasonic waves to the sub-surface internal defects. Phased array ultrasonic testing has been used in recent years to identify and characterize rail defects; however, even though phased-array systems have the potential to enhance defect identification, their application has been limited due to the requirement for contact between the rail and the probe.

There is a benefit and a need to improve nondestructive testing of railway tracks.

### SUMMARY

Disclosed herein is a non-contact, non-destructive evaluation rail damage detection system and method using a laser Doppler vibrometer (LDV) that can be implemented on a moving defect detection system via an impulsive noise filter. Conventional laser Doppler vibrometer measurements, when made during movements, e.g., across a rail segment, can exhibit impulse noise that can cause high levels of speckle noise/artifacts in the laser Doppler vibrometer measurements, which can distort or cause gaps in the measurements. The implementation of an impulsive noise filter enables the use of laser Doppler vibrometers for non-contact non-destructive evaluation of railways. An impulsive noise filter may be implemented in the acquisition hardware or in real-time, or post-processing analysis system to remove speckle noise and other unwanted interferences from the LDV data, to which defect detection can be subsequently employed.

The exemplary non-contact non-destructive evaluation rail damage detection system and method can be used to measure surface vibrations to sense guided waves using a laser beam directed onto a surface of interest and extracting, from the vibration amplitude and frequency, a Doppler shift of the reflected laser beam. The exemplary system and method can high-spatial resolution measurements in a wide range of frequencies.

In one example, in the pre-processing stage of the developed damage detection framework associated with the system, time-varying mean and impulsive noise in the recorded LDV signals can be filtered, and then the changes in the LDV signals are quantified and monitored using the moving standard deviation. The filtering step may include an impulsive noise filter to remove impulsive noise in the LDV system. In the post-processing stage, two damage features, which are based on the relative change in the computed moving standard deviations and transfer functions between two measurement points, are combined using multivariate statistical analysis to create a damage index that shows the location of rail segments that are affected by a defect. The analysis system may further determine the type of defect (e.g., transverse, surface, or missing fastener) based on the filtered LDV measurements. In some implementations, the exemplary system employs at least two LDVs mounted on a rail car, to record the waves induced on the rail head by random rail-wheel interaction forces. The recorded measurement can be analyzed using multivariate analysis that combines damage features which are based on the relative change in amplitude of the LDV signals that are caused by both reflected and transmitted waves.

The exemplary non-contact non-destructive evaluation rail damage detection system and method can be employed for other non-destructive evaluations, e.g., of roadways and pipelines, among other applications described or referenced herein.

A study was conducted that developed and validated the use of non-contact non-destructive evaluation based on laser Doppler vibrometry for railway defect detection using laser Doppler vibrometer placed on a moving platform to record rail vibrations induced by wheel-rail interactions. The study shows that the lift-off distance required between the rail and a sensor can be implemented using laser Doppler vibrometry. The study also developed a defect detector, e.g., as described in relation to FIG. 3. The study also developed a missing fastener detector, e.g., as described in relation to FIG. 4. The study also developed a joint detector, e.g., as described in relation to FIGS. 5A-5C using machine learning algorithms.

The exemplary non-contact non-destructive evaluation rail damage detection system and method can be expanded to detect other defects on the railway by employing similar hardware and analysis but for a different frequency spectrum, e.g., to detect rail segment affected by the presence of the welded joint. In some embodiment, machine learning operations can be used to supplement the defect detect.

In an aspect, a system is disclosed (e.g., mobile defect detection platform) for detecting internal defects in a railway track, the system comprising: a laser Doppler vibrometer sensor assembly mounted to a mobile defect detection platform having one or more excitation mechanisms (e.g., train wheel or external device) configured to cause impact forces on a railway track and generate transverse waves therein while the mobile defect detection platform is moving, the laser Doppler vibrometer sensor assembly being configured to sense and measure, at one or more locations relative to the excitation mechanism, while the mobile defect detection platform is moving, vibration measurements representing the transverse waves from vibrations of the railway track caused by the impact forces of the excitation mechanism (e.g., detecting a change in the relative amplitudes of the recorded waves caused by a defect), the laser doppler vibrometer sensor assembly comprising one or more laser Doppler vibrometer sensors and a coupling member configured to mount the one or more laser doppler vibrometer sensors to a portion of the mobile defect detection platform; wherein the vibration measurements are processed by one or more filters to (i) remove speckle noise caused by movement of the laser Doppler vibrometer sensor assembly along the railway track and (ii) correct distorted portions of the vibration measurements cause by impulses from train wheels of the mobile defect detection platform to generate a filtered vibration measurement, and wherein the filtered vibration measurements are analyzed to determine one or more defects in the railway track for maintenance, repair, or visualization of conditions of the railway track.

In some embodiments, the one or more filters comprises an impulsive noise filter configured to (i) detect an artificial peak and a fluctuation in a signal segment of the vibration measurements and (ii) smooth and interpolate the signal segment to generate the filtered vibration measurement.

In some embodiments, the system includes an analysis system comprising a processor and a memory having instructions stored thereon, wherein execution of the instructions by the processor causes the processor to: receive vibration data corresponding to the vibration measurements measured by the laser Doppler vibrometer sensor assembly;
detect, via an impulsive noise filter, a signal segment of the vibration data containing an impulsive noise artifact; replace or modify, via the impulsive noise filter, the detected signal segment with a corrected segment with the impulsive noise artifact removed or lessened to generate a filtered vibration data; and determine, the defect in the railway track using the filtered vibration data, wherein the determined defect in the railway track is outputted in a report (digital or physical) for maintenance, repair, or visualization of defects of the railway track.

In some embodiments, the laser doppler vibrometer sensor assembly comprises a first laser doppler vibrometer and a second laser doppler vibrometer, as the one or more laser doppler vibrometer sensors, wherein each of the first laser doppler vibrometer and the second laser doppler vibrometer is configured to capture vibration data representing vibrations of the railway track caused by the impact force of the excitation mechanism at a first location relative to the excitation mechanism and a second location relative to the excitation mechanism, respectively, wherein vibration data from the first laser Doppler vibrometer and the second laser Doppler vibrometer are compared or combined to one another to extract or determine signal features that informs the defect detection.

In some embodiments, the one or more filters (e.g., impulsive noise filter) include a signal smoothing operator configured to smooth the signal segment containing the artificial fluctuation, the smoothed signal segment having reduced higher frequency signal components.

In some embodiments, the one or more filters (e.g., impulsive noise filter) include an interpolation operator configured to interpolate the signal segment containing the artificial peak, the interpolation operator comprising an autoregressive model to interpolate the signal segment at the artificial peak.

In some embodiments, the processor is further configured to: apply a transfer function to adjust for differences in the speed of vibration data collection (e.g., speed of the mobile detection platform along the railway track).

In some embodiments, the one or more filters comprise a Phase Space Thresholding operator, a Stationary Wavelet Package Transformation Thresholding operator, an artificial peak and/or fluctuation operator, a moving average filter with Gaussian weights and Bilinear Interpolation, or a combination thereof.

In some embodiments, the analysis system further comprises: an anomaly detector comprising a trained AI model (e.g., LSTM model) configured to detect broken rails in the railway track based on the filtered vibration data, wherein the detected broken rails are outputted in the report (digital or physical) for maintenance, repair, or visualization of defects of the railway track.

In some embodiments, the analysis system further comprises: a missing rail fastener detector configured to perform modal analysis using the filtered vibration data.

In some embodiments, the trained machine learning model was trained using vibration data from one or more mobile defect detections platforms having varied speeds along the railway track, varied defect types, or varied environmental conditions.

In some embodiments, the defect in the railway track is surface defect on a surface of the railway track or a missing fastener adjacent to the railway track.

In some embodiments, the laser Doppler vibrometer sensor assembly is mounted to a rail car as the mobile defect detection platform, the rail car being movable along the railway track and comprising a frame as the coupling member extending therefrom.

In some embodiments, the laser Doppler vibrometer sensor assembly is operatively coupled to a global positioning system, the controller being configured annotate the one or more defects in the railway track with global positioning coordinate from the global positioning system.

In another aspect, an analysis system is disclosed for detecting defects in a railway track, the analysis system comprising a processor and a memory having instructions stored thereon, wherein execution of the instructions by the processor causes the processor to: receive vibration data corresponding to vibration measurements measured by a laser Doppler vibrometer sensor assembly; detect, via an impulsive noise filter, a signal segment of the vibration data containing an impulsive noise artifact; replace or modify, via the impulsive noise filter, the detected signal segment with a corrected segment with the impulsive noise artifact removed or lessened to generate a filtered vibration data; and determine, the defect in the railway track using the filtered vibration data, wherein the determined defect in the railway track is outputted in a report (digital or physical) for maintenance, repair, or visualization of defects of the railway track.

In some embodiments, the impulsive noise filter is further configured to (i) detect an artificial peak and a fluctuation in a signal segment of the vibration measurements and (ii) smooth and interpolate the signal segment to generate the filtered vibration measurement.

In some embodiments, the processor is further configured to apply a transfer function to adjust for differences in the speed of vibration data collection (e.g., speed of the mobile detection platform along the railway track).

In some embodiments, the analysis system further comprises: an anomaly detector comprising a trained AI model (e.g., LSTM model) configured to detect broken rails in the railway track based on the filtered vibration data, wherein the detected broken rails are outputted in the report (digital or physical) for maintenance, repair, or visualization of defects of the railway track.

In some embodiments, the trained machine learning model was trained using vibration data from one or more mobile defect detections platforms having varied speeds along the railway track, varied defect types, or varied environmental conditions.

In another aspect, a non-transitory computer-readable medium is disclosed having instructions stored thereon, wherein execution of the instructions by a processor causes the processor to perform any of the above discussed method or systems.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The systems, methods, and devices are explained in even greater detail in the following drawings. The drawings are merely exemplary and certain features may be used singularly or in combination with other features. The drawings are not necessarily drawn to scale.

FIG. 1 shows an example system for detecting defects in a railway track in accordance with an illustrative embodiment.

FIGS. 2A-2C show an example impulse noise filter for removing speckle noise in lasser Doppler vibrometer to detect defects in a railway track in accordance with an illustrative embodiment.

FIG. 3 shows an example defect detection module for detecting defects in a railway track in accordance with an illustrative embodiment.

FIG. 4 shows an example missing fastener detection module for detecting missing fastener defects in a railway track in accordance with an illustrative embodiment.

FIGS. 5A-5E show an example AI/ML joint detection module for detecting joint defects in a railway track in accordance with an illustrative embodiment.

FIGS. 6A-6H show characterization results and additional examples for the impulse noise filter of FIGS. 2A-2C.

FIGS. 7A-7F show characterization results and additional examples for the defect detection module of FIG. 3 using impulse noise filter of FIGS. 2A-2C.

FIGS. 8A-8E show characterization results and additional examples for the missing fastener detection module of FIG. 4 using impulse noise filter of FIGS. 2A-2C.

FIGS. 9A-9F show characterization results and additional examples for the joint defect detection module of FIG. 5 using impulse noise filter of FIGS. 2A-2C.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

Disclosed herein is a non-contact rail damage detection system based on laser Doppler vibrometer (LDV) measurements. Specifically, the system consists of two LDVs mounted on a rail car, to record the waves induced on the rail head by random rail-wheel interaction forces. The developed damage detection framework associated with the system is based on a multivariate analysis that combines damage features which are based on the relative change in amplitude of the LDV signals that are caused by both reflected and transmitted waves. Results show that the proposed system can identify the rail segment in which the propagating waves on the rail head are affected by the presence of the welded joint.

### Example System

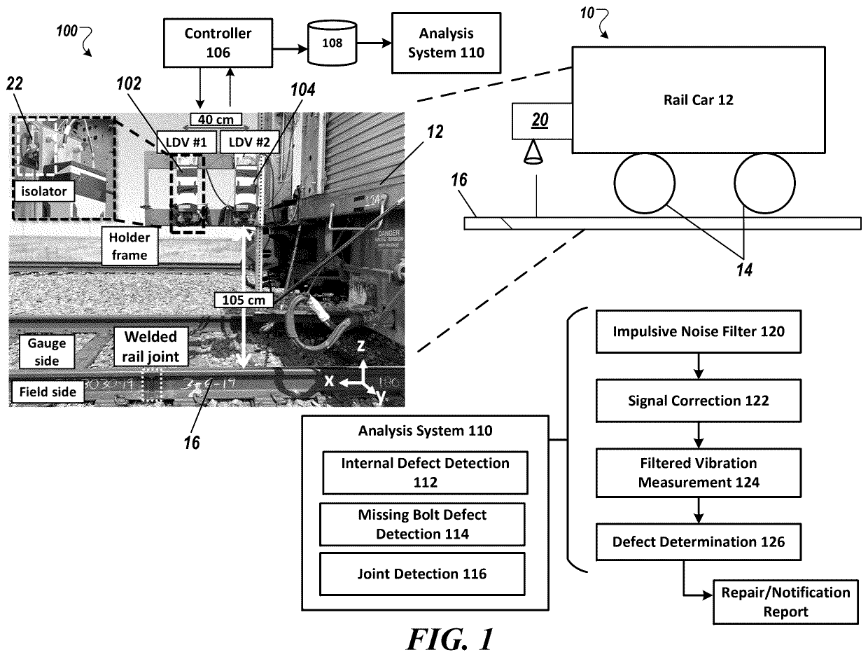

FIG. 1 shows an example system 10 for detecting defects in a railway track. The system 10 includes a laser Doppler vibrometer sensor assembly 100 mounted to a mobile defect detection platform (e.g., a moving vehicle) having one or more excitation mechanisms. As shown in the example of FIG. 1, the system 10 includes a rail car 12 configured as a mobile detection platform comprising a laser Doppler vibrometer sensor assembly 100. The rail car 12 has a plurality of wheels 14 configured to roll along a railway track 16 as the rail car 12 moves in a direction along the railway track 16; the wheels 14 in being in excitation contact with the tracks are configured to provide excitation mechanisms to the railway track 16 that generate transverse waves in the railway track 16 while the railcar 12 is moving. In other implementations, the excitation mechanism may be supplemented via an external device. The mobile detection platform may be configured with additional vehicle configured to move along a railway track (e.g., a truck with rail-enabled wheels), or other rail cars.

The laser Doppler vibrometer sensor assembly 100 includes laser Doppler vibrometer (LDV) sensors (e.g., 102, 104). The LDV sensors (e.g., 102, 104) are coupled to and/or in electrical communication with a controller 106. The controller 106 is configured to store the measurement data for real-time, onboard defect detection or store the measurement data for off-line, off-board defect detection. The laser Doppler vibrometer sensor assembly 100 may be equipped with impulsive noise filters to provide filtered data to the controller 106, the controller may be configured with an impulsive noise filter to provide filtered data storage, or the raw measurement may be filtered in post-processing using an impulsive noise filter. Description of the impulsive noise filter is later described herein.

As shown in FIG. 1, the laser Doppler vibrometer sensor assembly 100 is mounted to the rail car 12 via coupling members, e.g., a mounting frame 20. The mounting frame 20 may include, at one side, rigid members are fixably or removably coupled to a portion of the rail car 12 (e.g., via one or more fasteners) and, at another side, the laser Doppler vibrometer sensor assembly 100.

The laser Doppler vibrometer sensor assembly 100 includes laser Doppler vibrometer (LDV) sensors. As shown in FIG. 1, the laser Doppler vibrometer sensor assembly 100 includes a first LDV sensor 102 and a second LDV 104 coupled to and spaced apart from each other along the mounting frame 20. In particular, the first and second LDV sensors 102, 104 may be coupled to a portion of the mounting frame 20 via one or more isolators 22. The isolators 22 may insulate the LDV sensors 102, 104 from the vibrations of the rail car 12 to facilitate data collection. In some implementations, vibration data from the first laser Doppler vibrometer sensor 102 and the second laser Doppler vibrometer sensor 104 are compared or combined with one another to extract or determine signal features that inform the defect detection.

The laser Doppler vibrometer sensor assembly 100 is configured to sense and measure—at one or more locations along the railway track 16—vibration measurements in the railway track 16. Specifically, the laser Doppler vibrometer sensor assembly 100 is configured to sense and measure vibrations caused by the impact forces of the excitation mechanism (i.e., the plurality of wheels 14) as the rail car 12 moves along the railway track 16. For example, the laser Doppler vibrometer sensor assembly 100 may record and detect a change in the relative amplitudes of recorded waves (e.g., caused by a defect in the railway track 16). The LDV sensors 102, 104 are coupled to and/or in electrical communication with a controller 106.

The controller 106 is configured as a sensor controller or a sensor interface that is couplable to a data store 108 (e.g., a mobile computer coupled to the rail car 12 or the laser Doppler vibrometer sensor assembly 100). The controller 106 may include a processor and a memory storing instructions thereon that are executable by the processor. For example, the processor may initiate or stop a data collection operation (e.g., turn the LDV sensors 102, 104 on or off) based on instructions from the memory and/or a remote controller. In some implementations, the controller 106 is configured to connect to integrated or ruggedized data acquisition hardware (not shown). The controller 106 is further configured to collect and send laser Doppler vibrometer data from the LDV sensors 102, 104 to the data store 108. The controller 106 may collect and send other data types to the data store 108 as well (e.g., GPS data for each defect and/or the entire data set). The data store 108 is then configured to temporarily store and then delivery the laser Doppler vibrometer data to the analysis system 110.

The controller 106 and/or the analysis system 110 may include a transfer function configured to manipulate the vibration data from the laser Doppler vibrometer sensor assembly 100 before analysis. The transfer function may adjust for differences in the speed of vibration data collection (e.g., speed of the mobile detection platform along the railway track 16). For example, if training data concerning defect detection was performed at a certain speed of the rail car 12, but data collection in a trial is collected at a faster speed, the transfer function can correct for the difference in speed. The corrected data is then passed through the remainder of the analysis system 110. In other implementations, the transfer function is implemented into the analysis system 110 or a module thereof.

The analysis system 110 is configured to receive, filter, and interpret the laser Doppler vibrometer data associated with the laser Doppler vibrometer sensor assembly 100 and the railway track 16. In some embodiments, the analysis system 110 is a part of the laser Doppler vibrometer sensor assembly 100. In other implementations, the analysis system 110 may be remote to the laser Doppler vibrometer sensor assembly 100 (e.g., located a server or a cloud infrastructure that is configured to receive laser Doppler vibrometer data and analyze the data to determine a defect in the railway track 16).

The laser Doppler vibrometer sensor assembly 100 may include or be connected to a global positioning system (e.g., GPS-enabled). GPS data may be time synchronized or event synchronized to the laser Doppler vibrometer measurements. To this end, the detection of the presence of a defect in the railway at a particular measurement segment can be referenced or indexed to a GPS position or other positioning data.

As shown in FIG. 1, the analysis system 110 may be configured to detect one or more defects in the railway track 16 via one or more modules. Thus, the analysis system 110 may include one or more modules to simultaneously determine different types of track defects via different functions and/or analysis schemes. For example, the analysis system 110 includes an internal defect module 112. The internal defect module 112 is configured to identify a defect in the railway track 16 that is internal to the railway track 16. For example, defects that are not visible from the surface, such as a welded joint, internal cracks, internal voids, or imperfect joints may be considered internal defects. The internal defect module 112 is configured to analyze specific frequency ranges from the laser Doppler vibrometer data, as further described herein.

Defect Detection using Impulsive Noise Filtering. After receiving vibration data measured by the laser Doppler vibrometer sensor assembly 100, the analysis system 110 is configured to filter and correct the data to remove/replace noise in the system 10. For example, excess noise in vibration data may be present due to the motion of the rail car 12 along the railway track 16 and the corresponding motion of the LDV sensors 102, 104 mounted thereto. Thus, the analysis system 110 includes one or more filters to remove speckle noise caused by movement of the laser Doppler vibrometer sensor assembly 100 along the railway track 16. The analysis system 110 further includes one or more filters to correct distorted portions of the vibration measurements caused by impulses from the plurality of wheels 14 of the rail car 12. Thus, the analysis system 110 produces a filtered vibration measurement and/or data set which is then analyzed by the internal defect module 112. The analysis system 110 may include other modules for other defect detections, e.g., a missing bolt detection algorithm (114) and a joint detection algorithm (116).

Included among the filters used in the analysis system 110 is an impulsive noise filter 120, as shown in FIG. 1. The IN filter 120 of the analysis system 110 may include a Phase Space Thresholding operator, a Stationary Wavelet Package Transformation Decomposition Thresholding operator, a moving average filter with Gaussian weights and Bilinear Interpolation, or a combination thereof. The impulsive noise filter 120 is configured to detect an artificial peak, fluctuation, or other impulsive noise artifact in a signal segment of the vibration measurements from the laser Doppler vibrometer sensor assembly 100. The impulsive noise filter 120 is configured to smooth and interpolate the signal segment to generate the filtered vibration measurement. The impulsive noise filter 120 may include a signal smoothing operator configured to smooth the signal segment containing the artificial fluctuation, the smoothed signal segment having reduced higher frequency signal components. For example, the impulsive noise filter 120 may identify a signal segment including an impulsive noise artifact and send that signal segment to a signal correction module 122 of the analysis system 110. Additionally, the impulsive noise filter 120 may include an interpolation operator configured to interpolate the signal segment containing the artificial peak, the interpolation operator comprising an autoregressive model to interpolate the signal segment at the artificial peak.

The signal correction module 122 may be a part of the impulsive noise filter 120 or separate from the impulsive noise filter 120. The signal correction module 122 is configured replace or modify the signal segment containing the impulsive noise artifact (e.g., speckle noise) with a corrected segment that does not include the impulsive noise artifact- or at least wherein the impulsive noise artifact is lessened. Thus, the signal correction module 122 provides filtered vibration data to the filtered vibration measurement module 124.

The filtered vibration measurement module 124 of the analysis system 110 is configured to measure the filtered vibration data to identify a segment corresponding to a track defect. For example, the filtered vibration measurement module 124 may identify a first segment corresponding to a frequency range matching that of the internal defect module 112 or the missing bolt detection module 114. Then, the defect determination module 126 compares the segment identified by the filtered vibration measurement module 124 to existing data sets to finalize the defect determination.

In some implementations, the filtered vibration measurement module 124 and/or the defect determination module 126 of the analysis system 110 include a machine learning and/or artificial intelligence module (e.g., 116) to analyze the laser Doppler vibrometer data. For example, the analysis system 110 may be configured with an anomaly detector including a trained AI model (e.g., LSTM model) configured to detect broken rails in the railway track based on the filtered vibration data. The trained machine learning model may have been trained using vibration data from one or more mobile defect detections platforms having varied speeds along the railway track, varied defect types, or varied environmental conditions.

In some implementations, the filtered vibration measurement module 124 and/or the defect determination module 126 of the analysis system 110 include other defect modules (e.g., 114). For example, the analysis system 110 may be configured to perform modal analysis of laser Doppler vibrometer data to detect missing fasteners using the filtered vibration data.

Once the defect is determined by the analysis system 110, the system 10 may output a repair or notification report. For example, the analysis system 110 can store data about the defects identified, the type of defect, the defect location along the railway track 16, and/or visual data about the defect. This report may be a digital or physical report generated by the system 10. The report is then communicated to a user who can take action to find and repair the railway track 16 as needed.

Other Defect Detection. Referring back to FIG. 1, the analysis system 110 may further includes a missing bolt detection module 114. Similar to the internal defect module 112, the missing bolt detection module 114 analyzes specific frequency ranges to identify a missing fastener on or adjacent to the railway track 16. However, the missing bolt detection module 114 analyzes a different frequency range than the internal defect module 112 due to the different behavior of the defect type. In other implementations, other defects may be detectable based on other frequency analysis.

### Example Impulsive Noise Filter

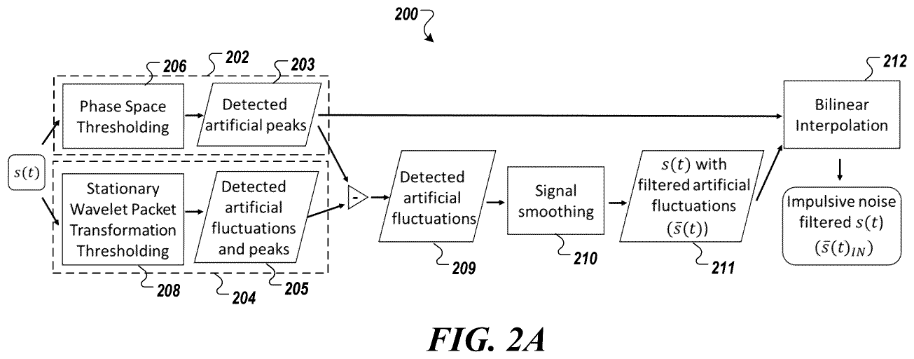

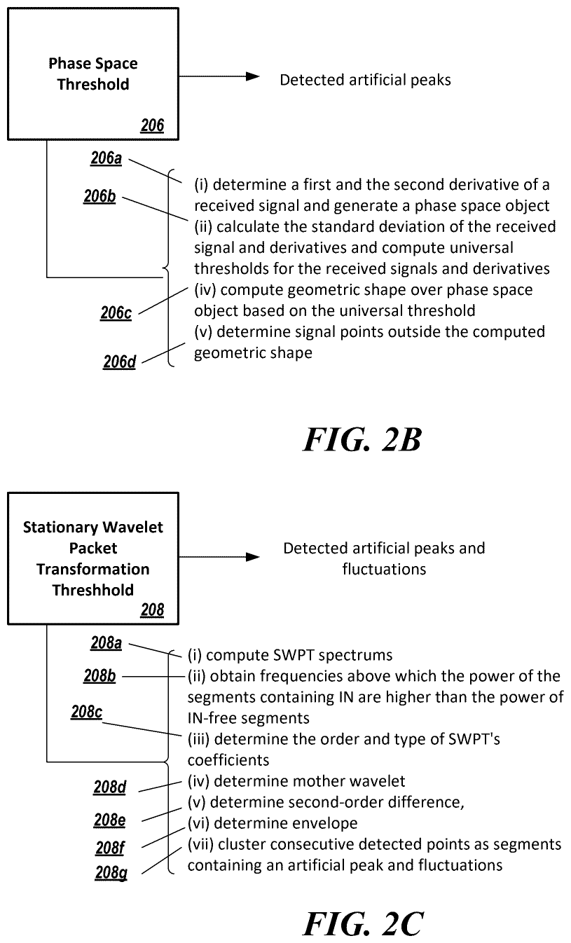

FIG. 2A shows an impulse noise filter 200 (previously shown as 120) executed using (i) a detection operation (202, 204) to detect artificial peak (203) and a combination of artificial peaks and fluctuation (205) in a segment using a Phase Space Threshold operator (206) and a Stationary Wavelet Package Transformation Threshold operator (208), respectively, (ii) a smoothing filter (e.g., comprising moving average filter) (210), and an estimation operation (212). In some embodiments, Hampel Identifier may be employed for artificial peak detection. In some embodiments, the moving average filter employs a moving average filter with Gaussian weights. In some embodiments, the estimation operation employs a Bilinear Interpolation (212) to replace the detected segments to estimate their IN-free values (208). The filter 200 may determine the signal segments containing the artificial fluctuations (205) by subtracting the segments containing an artificial peak (e.g., determined from operation 202) from the segments containing both an artificial peak and fluctuations (e.g., determined from operation 204).

Artificial Peak Detector (202). FIG. 2B shows a Phase Space Thresholding operation (206) that, for a received signal, via operation 206a, determines a first and the second derivative of the received signal and generate a phase space object of the received signal, the first derivative, and the second derivative. For an input signal, s(t), the first and the second derivative of s(t) may be calculated per Equation Set 1 where N is the number of signal points in s(t).

$$\dot{s} ( {τ}_{n} ) = \frac{s ( {t}_{n + 1} ) - s ( {t}_{n - 1} )}{2 * 1} , n = 1 , … , N \ddot{s} ( {t}_{n} ) = \frac{\dot{s} ( {t}_{n + 1} ) - \dot{s} ( {t}_{n - 1} )}{2 * 1} , n = 1 , … , N \qquad ( Eq . Set 1 )$$

The Phase Space Thresholding operation (206) then, via operation 206b, determines the standard deviation of the received signal and derivatives and compute universal thresholds for the received signals and derivatives. The universal threshold for s(t) may be determined per Equation 2.

λₛ₍ₜ₎=\sqrt{2 ln N}σₛ₍ₜ₎ (Eq. 2)

The Phase Space Thresholding operation (206) then, via operation 206c, computes a geometric shape (e.g. ellipsoid, circle, square, or other geometric shape) over phase space object based on the universal threshold. For example, using ellipsoids, the ellipsoids may be computed in the phase space object. The length of the minor and major axis (i.e., a and b, respectively) of the ellipsoids may be determined where (i) a and b for the s(t) vs. \dot{s}(t) phase space are λₛ₍ₜ₎ and λ_{\dot{s}(t)}, respectively; (ii) a and b for the \dot{s}(t) vs. \ddot{s}(t) phase spaces are λ_{\dot{s}(t)} and λ_{\ddot{s}(t)}, respectively; and (iii) a and b for the s(t) vs. \ddot{s}(t) phase space may be calculated per Equation Set 3A.

$$a = \sqrt{\frac{{λ}_{s ( t )}^{2} {cos}^{2} θ - {λ}_{\ddot{s} ( t )}^{2} {sin}^{2} θ}{{cos}^{4} ϑ - {sin}^{4} ϑ}} b = \sqrt{\frac{{λ}_{\ddot{s} ( t )}^{2} {cos}^{2} θ - {λ}_{s ( t )}^{2} {sin}^{2} θ}{{cos}^{4} ϑ - {sin}^{4} ϑ}} \qquad ( Eq . Set 3 A )$$

In Equation Set 3A, θ is the rotational angle of the ellipsoid may be determined per Equation 3B.

$$θ = {tan}^{- 1} ( \frac{{\sum }_{n = 1}^{N} s ( {t}_{n} ) \ddot{s} ( {t}_{n} )}{{\sum }_{n = 1}^{N} {s ( {t}_{n} )}^{2}} ) \qquad ( Eq . 3 B )$$

The Phase Space Thresholding operation (206) then, via operation 206d, determine signal points outside the computed geometric shape as data points corrupted by artificial peaks and the values are replaced until no further points meet such criterion. In some embodiment, an estimation method may be employ to replace the detected signal points that includes: (i) determining the length of one of the longest signal segments containing an artificial peak in terms of signal points (i.e., N_{p̅} signal points), (ii) placing a signal window of length 2N_{p̅}+1 on the each detected point, and (iii) replacing each point by a median of the signal window. Additional examples and configuration are described in relation to Table 1A.

To improve the detection performance and minimize false positives, additional operation may be performed to (i) group consecutive detected points as segments containing an artificial peak, (ii) determine minimum length of detected segment, and (iii) combine segments with a distance less than a pre-defined signal point. Description of the optional operation is also provided in Table 1A.

Detection of Artificial Fluctuations (205). The filter 200 may determine the signal segments containing the artificial fluctuations (205) by subtracting the segments containing an artificial peak (e.g., determined from 202) from the segments containing both an artificial peak and fluctuations (e.g., determined from 204). Fluctuations may be detected using Stationary Wavelet Package Decomposition Thresholding operation (208) that combines Stationary Wavelet Packet Transformation (i.e., SWPT) [38], [70] (i.e., shift-invariance) and Discrete Wavelet Package Transformation (i.e., high-resolution decomposition) [71]. Other wavelet transformation may be employed [36], [37].

Stationary Wavelet Package Decomposition Thresholding (208). The Stationary Wavelet Package Transformation Threshold operator (208) may (i) compute the SWPT spectrums, (ii) obtain frequencies, above which the power of the segments containing IN are higher than the power of IN-free segments, (iii) determine the order and type of SWPT's coefficients, (iv) determine the mother wavelet, (v) determine the second-order difference, (vi) determining the envelope of |Δ²wₛ₍ₜ₎|(E_{|Δ}_{²}_{w}_{ₛ₍ₜ₎}_{|}), and (vii) cluster the consecutive detected points as segments containing an artificial peak and fluctuations, per Table 1B.

FIG. 2C shows an example of the Stationary Wavelet Package Transformation Threshold operator (208). The Stationary Wavelet Package Transformation Threshold operator (208), via operator 208a, may compute the SWPT spectrums of s(t) using a set of candidate mother wavelets, e.g., Symlet (e.g., with order between 2 and 6), Daubechies (e.g., with order between 2 and 6), and Coiflet (e.g., with order between 2 and 5).

The Stationary Wavelet Package Transformation Threshold operator (208), via operator 208b, may obtain frequencies, above which the power of the segments containing IN are higher than the power of IN-free segments. The operator 208b may determine the total power at each frequency bin up to the maximum frequency content for the SWPT spectrums (determined from 208a). For each spectrums, the frequency bin at which the behavior of total power changes may be determined by finding the data point at which the trend of data changes (i.e., knee point), e.g., fitting pairs of two lines to data points which are separated by each different data point and determining the pair of two lines where minimum fitting error is found. The separating frequency may then be obtained by calculating the average of all knee frequencies obtained from the different spectrums.

The Stationary Wavelet Package Transformation Threshold operator (208), via operator 208c, may determine the order and type of SWPT's coefficients which cover the region between the separating frequency and the maximum frequency content the most (i.e., the decomposition coefficients).

The Stationary Wavelet Package Transformation Threshold operator (208), via operator 208d, may determine the mother wavelet. The operator 208d may sort the output of the mother wavelet analysis to which the wavelet coefficients corresponding to the higher order (e.g., between 5% and 25%), the median order (e.g., between 25% and 75%)), and the lowest order (e.g., between the 75% and 95%) are averaged. The wavelet that produce a maximization of Equation 4 is selected as the mother wavelet.

$$\vert ( {μ}_{{s ( t )}_{\text{.15}}}^{c} - {μ}_{{s ( t )}_{\text{.50}}}^{c} \vert + ( {μ}_{{s ( t )}_{\text{.85}}}^{c} - {μ}_{{s ( t )}_{\text{.50}}}^{c} ) \qquad ( Eq . 4 )$$

Eq. 4 maximizes the difference between the segments containing IN

$$( represented by {μ}_{{s ( t )}_{\text{.15}}}^{c} and {μ}_{{s ( t )}_{\text{.85}}}^{c} )$$

and the IN-free segments

$$( represented by {μ}_{{s ( t )}_{\text{.50}}}^{c} ) .$$

The Stationary Wavelet Package Transformation Threshold operator (208), via operator 208e, may determine the second-order difference per Equation 4.

Δ²wₛ₍ₜ₎=[0Δ(−Δwₛ₍ₜ₎)0] (Eq. 5)

In Equation 5, Δ is the difference in the consecutive wₛ₍ₜ₎ points.

The Stationary Wavelet Package Transformation Threshold operator (208), via operator 208f, may determine the envelope of |Δ²wₛ₍ₜ₎|(E_{|Δ}_{²}_{w}_{ₛ₍ₜ₎}_{|}). The envelope of |Δ²wₛ₍ₜ₎|(E_{|Δ}_{²}_{w}_{ₛ₍ₜ₎}_{|}) is calculated. This is achieved by using the maximum value in the moving windows of |Δ²wₛ₍ₜ₎|. The moving window length is selected based on the dominant distance between the peaks of |Δ²wₛ₍ₜ₎|, which is three signal points for Δ²wₛ₍ₜ₎. Then, the threshold (i.e., Wthr) is calculated using the median of |Δ²wₛ₍ₜ₎|.

The Stationary Wavelet Package Transformation Threshold operator (208), via operator 208g, may cluster the consecutive detected points as segments containing an artificial peak and fluctuations, per Table 1B. Then, the difference between such segments and the segments containing an artificial peak (found using Phase Space Thresholding) are used to obtain the segments containing artificial fluctuations.

Smoothing Filter to Replace Artificial Fluctuations. Segments containing artificial fluctuations (209) can result from an increase in the frequency of the speckle noise in the proximity of the artificial peaks. The filter 200 may employ a moving average filter (e.g., with Gaussian weights) in a signal smoothing operation to replace the segments containing artificial fluctuations with a signal having filtered artificial fluctuations (211). The smoothing operation (210) can decrease the power at high frequencies while not completely removing them since its cut-off frequency exhibit, e.g., a smooth shape. The smoother operator may be expressed per Equation 6.

$$s ( {t}_{A + n} ) = {w}_{1} s ( {t}_{A + n - ( k / 2 ) - 1 )} ) + … + {w}_{k} s ( {t}_{A + n + ( \frac{k}{2} )} ) , n = 0 , … , {N}_{f} \qquad ( Eq . 6 )$$

In Equation 6, w is the weight vector, k is an even number indicating the length of the signal points that are used to calculate the moving average, and N_{F} is the number of signal points in the segment. The values of the weight may be chosen according to Gaussian distribution, and their sum equaled one. The values of s(t) before t_{A} and after t_{B} may be considered to be zero so that signal points outside the segment are not considered in the moving window. If the filter length is odd, s(t_{A+n}) is centered in the middle of the moving window. The moving window length (k) is set to 8 if N_{f}≥8.

Replacement of Artificial Peaks Using Bilinear Interpolation (212). The filter 200 may implement an interpolation operation, e.g., Bilinear Interpolation to replace segments containing an artificial peak. The bilinear interpolation operation may be configured to perform forward linear prediction, backward linear prediction, and their combination. Forward linear prediction based approach replaces the segments by interpolating the IN-free segments located at two sides of the replaces segment. The interpolation may be performed using autoregressive modeling whose parameters are determined from the IN-free segment located before the replaced segment.

The bilinear interpolation is configured to replace the segment containing the artificial peak by estimating the IN-free values of signal points in that segment using the preceding r number of signal points. The operation also estimates the values of the signal points in the second IN-free segment using the preceding r number of signal points. The operation may be carried out based on the minimization in the mean-square sense, e.g., per Equation 7A.

$$\{ \overline{s} ( {t}_{E} ) , … , \overline{s} ( {t}_{F} ) \} = {arg min}_{\overline{s} ( {t}_{E} ) , … , \overline{s} ( {t}_{F} )} {\sum }_{j = 0}^{{N}_{P} + r - 1} {[ \overline{s} ( {t}_{E + j} ) - {\sum }_{k = 1}^{r} {φ}_{k} \overline{s} ( {t}_{E + j - k} ) ]}^{2} = {arg min}_{{ψ}_{e}} {ψ}^{T} {B}^{T} B ψ \qquad ( Eq . 7 A )$$

In Equation 7A, φ is the vector of autoregressive model coefficients, r is the order of autoregressive model, ψ is the vector of signal points used in estimation (i.e., ψ=[s̅(t_{E-r}), . . . , s̅(t_{F+r})]^{T}), ψₑ is the vector of the replaced segment, and B is a (r+N_{P}) by (2r+N_{P}) matrix. The matrix B includes the elements of φ. When all detected segments containing artificial peaks are replaced, IN filtered s(t) (s̅(t)_{IN}) is obtained. The value of r maybe chosen per Equation 7B to be as large as possible.

$$r = \{ \begin{matrix}\frac{{N}_{B}}{2} if \frac{{N}_{B}}{2} \geq {N}_{A} \\ {N}_{A} otherwise\end{matrix} \qquad ( Eq . 7 B )$$

The backward prediction method may determine the lower and upper bounds for the length of the IN-free segments located before and after the segment containing an artificial peak are N_{P} and 2N_{P}, and 2N_{P} and 4N_{P}, respectively. In this case, r may be found by switching the location of N_{A} and N_{B} in Equation 7B.

The approach combining the forward and backward linear prediction may calculate the weighted sum of the IN-free signal points. These weights may be calculated based on the local predictive performance. The lower and upper bounds for the length of the IN-free segments located before and after the segment containing an artificial peak may be set to be 2N_{P} and 4N_{P}, respectively. The value of r may be chosen as the larger value of N_{B}/2 and N_{A}/2.

For Bilinear Interpolation to perform efficiently, r should be smaller than or equal to the maximum order of the model (i.e., r_{M}). The maximum model order is the number of subsequent signal points after a given signal point with a high level of correlation with the given signal point. The higher the model order, the more segments with larger lengths that contain an artificial peak can be estimated reliably. Table 1C shows further operations for a Bilinear Interpolation.

### Example Damage Detection

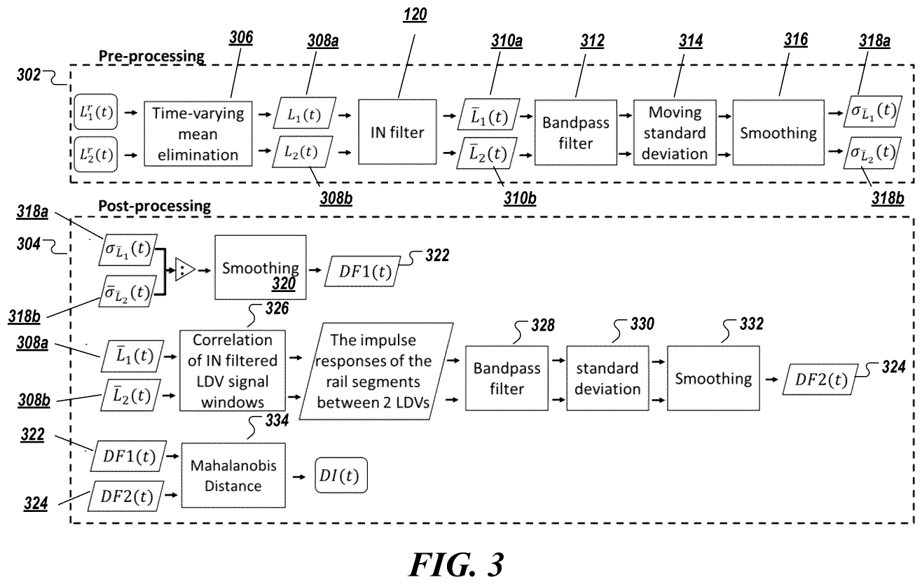

FIG. 3 shows a flowchart of the damage detection framework using the LDV measurements of the present disclosure (e.g., for the analysis system 110 of system 10). In the pre-processing stage, initially, the time-varying mean and impulsive noise of two raw signals

$$( {L}_{1}^{r} ( t ) and {L}_{2}^{r} ( t ) )$$

were eliminated, leading to signals L̅₁(t) and L̅₂(t) (see FIG. 2B, panel (a)). Then, the changes in the LDV signals are quantified and monitored using smoothed moving standard deviation in the frequency range of interest, leading to σ̅_{L̅}_{₁}(t) and σ̅_{L̅}_{₂}(t). In the post-processing stage, two damage features (i.e., DF1(t) and DF2(t)), which are based on relative change in the smoothed moving standard deviations of the LDV signals (computed in the previous stage) and the smoothed standard deviations of the transfer functions between two measurement points (computed at the post-processing stage), are combined using multivariate statistical analysis (i.e., joint detection approach) to create a damage index (DI(t)), as shown in FIG. 2B, panels (b), (c) and (d).

FIG. 3 shows an example damage detection algorithm, e.g., of traverse waves, using LDV measurements acquired on a moving platform (e.g., traveling at 10 mph, 20 mph, 30 mph, etc.). In the example shown in FIG. 3, the damage detection algorithm includes a pre-processing operation 302 and a post-processing operation 304.

Pre-processing (302). The pre-processing operation 302 notably employs the impulsive noise filter (e.g., 120, 200). The operation 302 may initiate by filtering (306) the time-varying non-zero mean by subtracting the moving average of the LDV signals from the signals themselves, leading to L₁(t) and L₂(t) (308a, 308b). The time-varying mean filter may employ moving mean and standard deviation of a segment of s(t) (e.g., moving window length of 0.001 seconds). The operation 302 may then process the signals with the impulsive noise filter (e.g., 120, 200) to generate filtered output 310a, 310b.

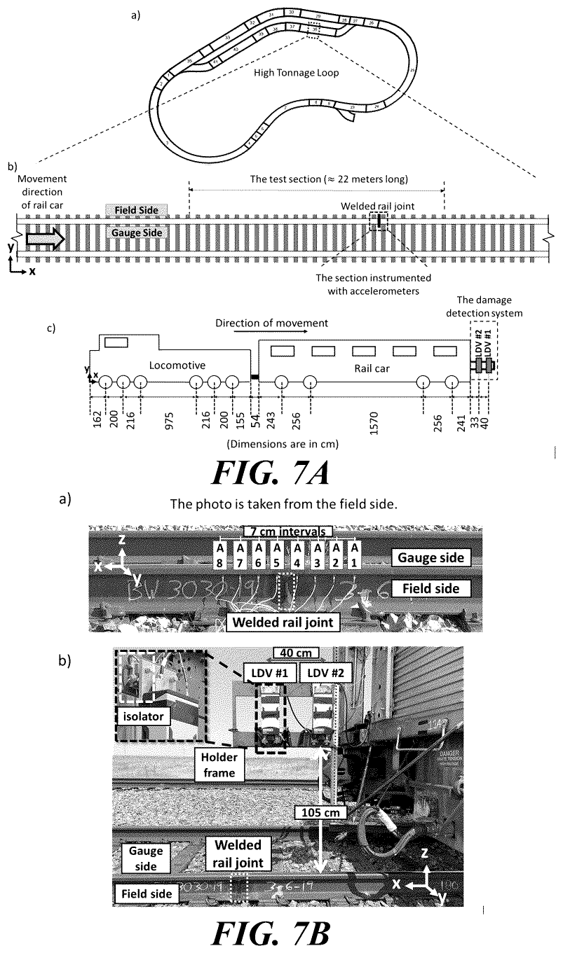

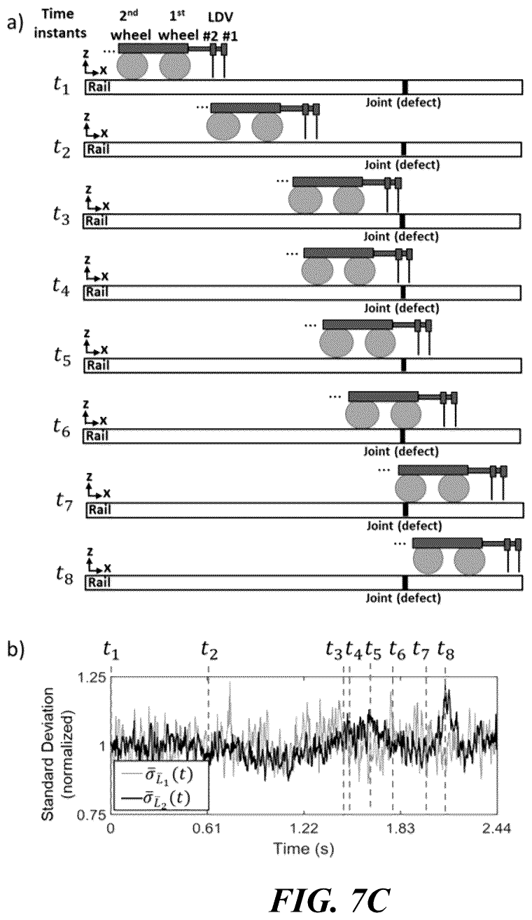

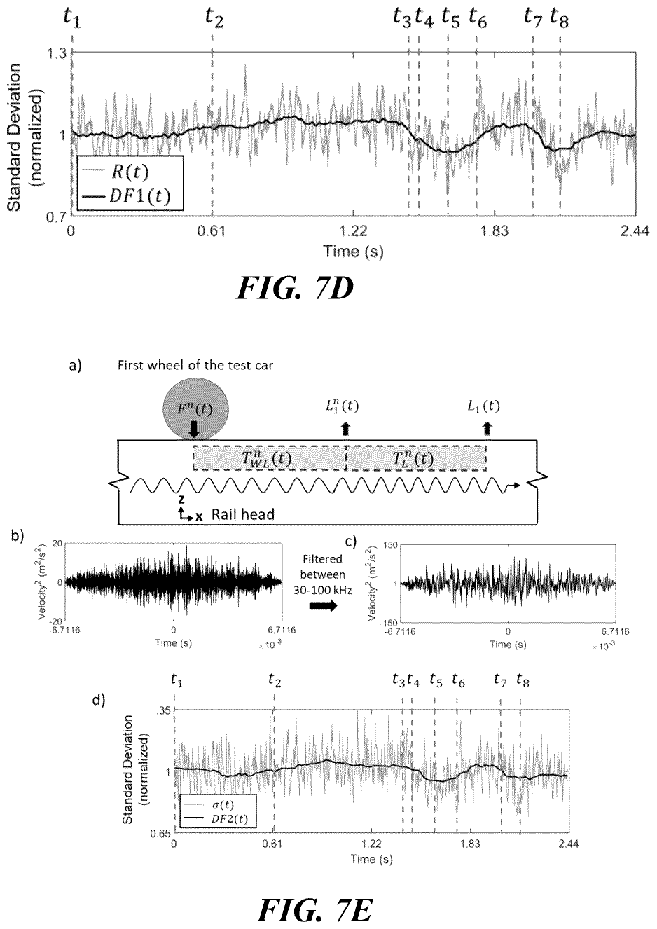

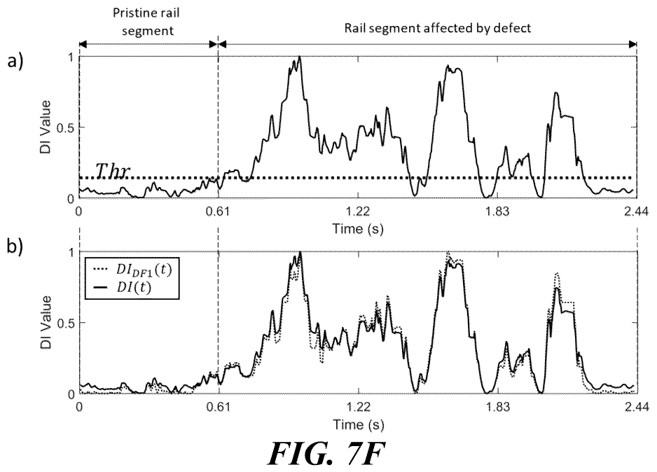

FIG. 7D illustrates an example of L₁(t) and L₂(t) along with L̅₁(t) and L̅₂(t). The figure shows that (i) LDV signals can exhibit more impulsive behavior as the speed increase, (ii) the amplitude of the second LDV's signals can be higher than the amplitude of the first LDV's signals (due to higher signal-to-noise ratio caused by the tri-beam feature of the second LDV), and (iii) the second LDV can exhibit a more impulsive behavior.

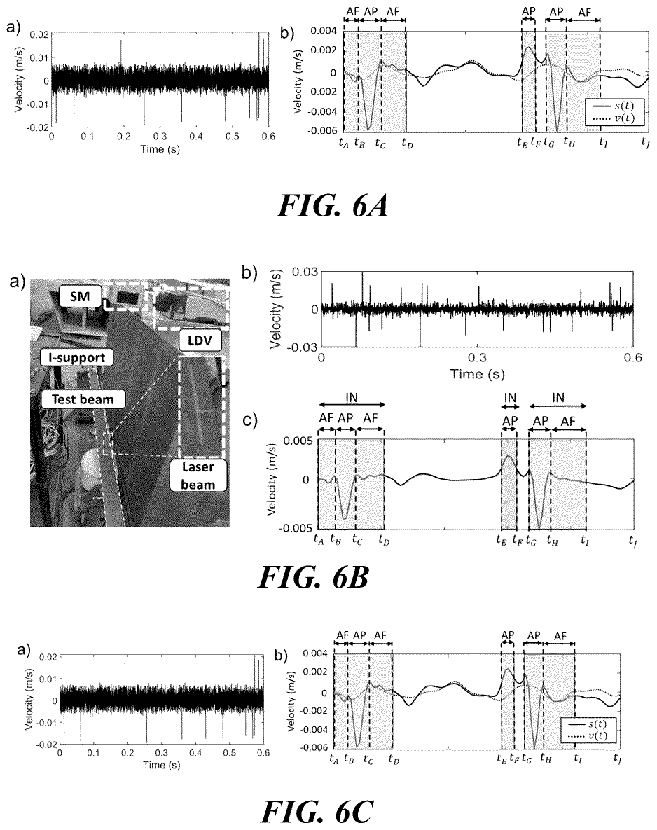

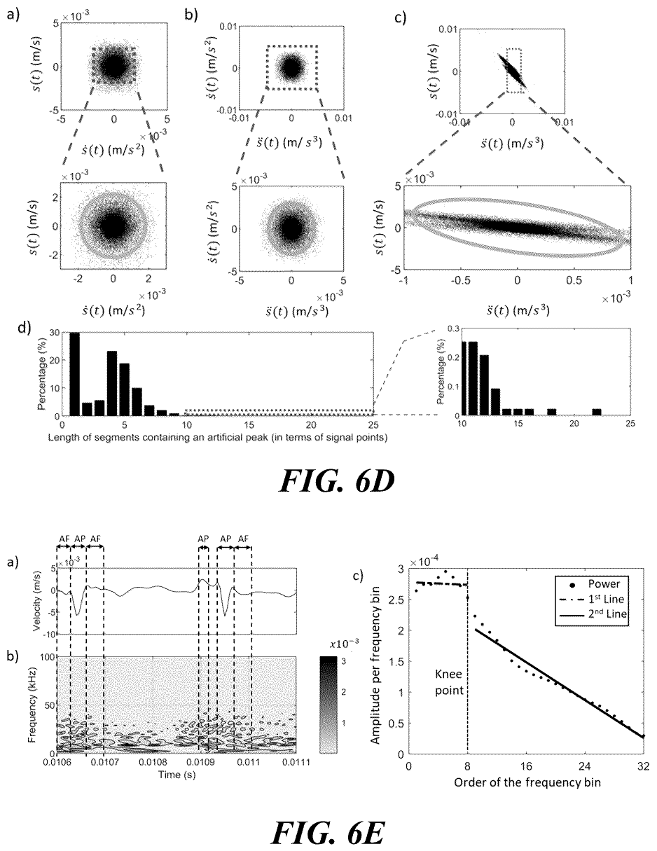

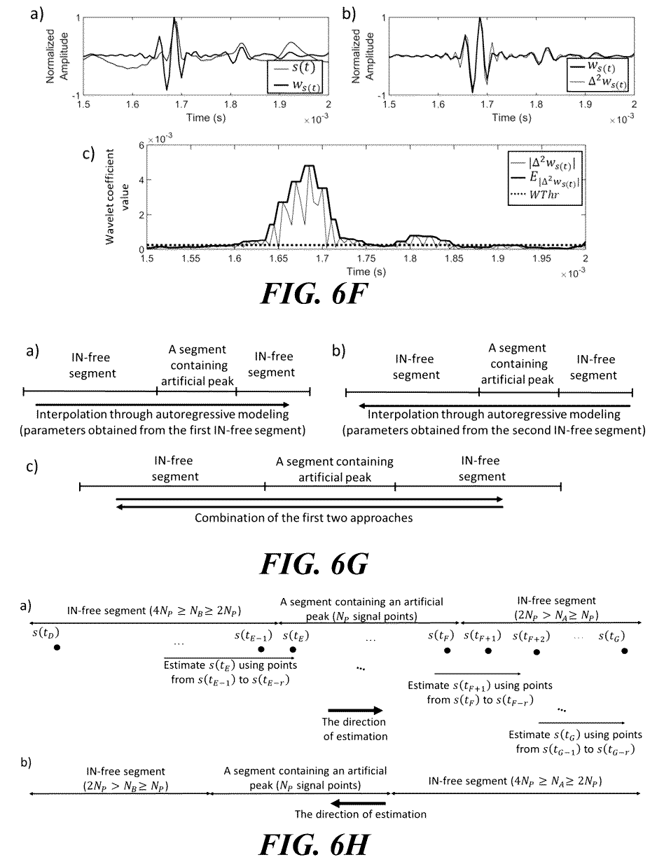

FIG. 7E, panels (a) and (b) show the entire length of L̅₁(t) along with L₁(t), as well as the entire length of L̅₂(t) along with L₂(t), which were obtained from LDV measurements recorded at 32 km/h (20 mph). FIG. 6E also shows that the overall amplitude of L̅₂(t) was higher than the one of L̅₁(t).

In the next step of pre-processing, the operation 302 can quantify and monitor the changes in LDV signals' amplitude due to their interaction with the defect using a moving standard deviation as the signal feature, e.g., implemented using bandpass filter 312 that filters L̅₁(t) (310a) and L̅₂(t) (310b) in the frequency range of interest, resulting in L̅_{b1}(t) and L̅_{b2}(t), respectively. Then, the moving sample standard deviation (314) of L̅_{b1}(t) and L̅_{b2}(t) (i.e., σ_{L̅}_{₁}(t) and σ_{L̅}_{₂}(t)) may be calculated. The moving windows' length (in terms of signal points) nay be chosen as a multiple (e.g., 64 times) of the mean of differences between the local peaks of L̅_{b1}(t) and L̅_{b2}(t) to eliminate the effect of noisy peaks (which are more in L̅_{b1}(t)). Thus, a broad behavior of the propagating waves is revealed as illustrated in FIG. 6E, panels (c) and (d) which show a small segment of L̅_{b1}(t) and L̅_{b2}(t) along with σ_{L̅}_{₁}(t) and σ_{L̅}_{₂}(t). Next, smoothing (316) may be performed, e.g., using moving median to further reduce the fluctuations in the moving standard deviations, leading to σ̅_{L̅}_{₁}(t) (318a) and σ̅_{L̅}_{₂}(t) (318b). The moving windows' length to compute the moving median may be chosen as the quarter of the time required for the rail car to travel the distance between the LDVs so that the relative change of signal's standard deviation due to passing over the defect was not over-smoothed.

The fluctuations observed in L̅_{b1}(t) and L̅_{b2}(t) might be attributed to the constructive and destructive interference of different propagating waves, which may be observed in the finite element simulations of the damage detection system. FIGS. 6E, panels (e) and (f) show examples of σ_{L̅}_{₁}(t) and σ_{L̅}_{₂}(t) along with their moving medians (i.e., σ̅_{L̅}_{₁}(t) and σ̅_{L̅}_{₂}(t)). The figures show the smoothing helping reduce the fluctuations.

Post-processing (304). To compute the first feature (i.e., DF1(t)) used in post-processing stage, the ratio between σ̅_{L̅}_{₁}(t) and σ̅_{L̅}_{₂}(t) (i.e., R(t)) may be computed per Equation 8A.

R(t)=σ̅_{L̅}_{₁}(t)/σ̅_{L̅}_{₂}(t) (Eq. 8A)

Then, R(t) may be normalized by dividing R(t) with the mean of its values at the rail segment which is not affected by the defect. Afterward, DF1(t) (322) may be obtained by smoothing R(t) with a moving median (320). The moving window length may be selected as the quarter of the time duration that is between the following time instants: (i) when σ̅_{L̅}_{₁}(t) and σ̅_{L̅}_{₂}(t) started to deviate from their approximately constant values due to the reflection of the waves from the defect (i.e., t₂), and (ii) when the first LDV was located right before the defect (i.e., t₃). An example of the moving window length is 0.216 seconds.

FIG. 7D shows the trend of R(t), before and after the joint along with DF1(t). This figure shows that DF1(t) exhibited almost constant values between t₁ and t₂, which corresponds to the rail segment that was not affected by the defect (i.e., pristine rail segment), and increasing and decreasing values in the rail segment affected by the defect (after t₂). Such behavior of DF1(t) is also similar to the behavior of a function used in finite element method simulations of the system, which also evaluated the relative change of propagating waves in the rail head at two measurement points.

The second damage feature (DF2(t)) (324) may be obtained using a transfer functions (e.g., correlation function) (326) between the LDV measurements (308a, 308b) that correspond to movement of the system, which overlap with each other with a ratio of 33%. On this figure,

$${\overline{L}}_{1}^{n} ( t ) , {\overline{L}}_{2}^{n} ( t )$$

and Fⁿ(t) refer to the recorded two LDV signals and the excitations induced by the wheel-rail interactions at the location of the first wheel during the discretized movement of the damage detection system, respectively (where n denotes the number of the

In the next step, each

$${T}_{L}^{n} ( t )$$

is bandpass filtered (328) in the frequency range of interest and then its standard deviation (330)

$$( i . e . , {σ}_{{T}_{L}^{n}} ( t ) )$$

is computed. Next,

$${σ}_{{T}_{L}^{n}} ( t ) ’ s$$

are combined in order to form an array σ_{T}_{_{L}}(t). Then, similar to the smoothing of R(t), σ_{T}_{_{L}}(t) is smoothed (332) using moving median where the length of the moving windows is selected as the moving window length used in the smoothing of R(t). Subsequently, one more smoothing is performed since the first smoothing might not be very efficient due to the discretized movements of LDVs in the transfer function approach. The window length for the second smoothing is selected as the time required for the rail car to travel half of the distance between LDVs. Finally, to obtain DF2(t), the double smoothed σ_{T}_{_{L}}(t) is interpolated to have the same number of points as DF1(t).

Finally, the joint detection approach is implemented using a multivariate analysis, which combines DF1(t) (322) and DF2(t) (324) to identify the rail segment affected by the defect. To achieve this, at first, a two-dimensional damage feature (DF(t)) is generated by merging the damage features per Equation 8B.

$$DF ( t ) = [ \begin{matrix}DF 1 ( t ) \\ DF 2 ( t )\end{matrix} ] \qquad ( Eq . 8 B )$$

Then, a two-dimensional distribution maybe created using the points of DF(t) corresponding to the pristine rail segment. The mean and covariance matrix of this distribution are denoted as μ and Σ, respectively. Afterward, the Mahalanobis distance (334) between each point of DF(t) and the distribution (i.e., D_{M}(t)) may be computed [6] per Equation 8C.

D_{M}(t)=(DF(t)−μ)^{T}Σ⁻¹(DF(t)−μ) (Eq. 8C)

Subsequently, the D_{M}(t) is normalized with respect to its maximum value to obtain the damage index (DI(t)). At the final step of the post-processing stage, to determine the rail segment in which the propagating waves were affected by the defect, a threshold is placed on DI(t) which is calculated as the sum of the sample mean and three sample standard deviation of DI(t) at the intact rail segment.

### Example Missing Fastener Detection

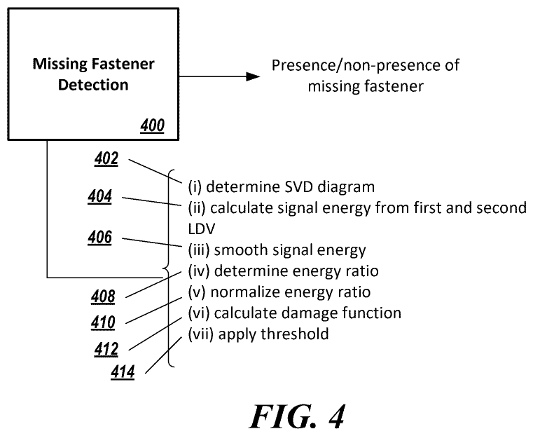

FIG. 4 show an example missing fastener detection algorithm 400 (e.g., implemented by module 114). The algorithm may determine (402) for every time instant, analyzing using FDD the acceleration data obtained from the two LDVs to obtain a SVD diagram. The signal energy in the frequency range of 4 kHz to 6 kHz may be used as the feature for the detection of the missing rail fastener. The signal energy at the frequency range of interest (4.0 kHz to 6.0 kHz) may be obtained from the LDVs using Equation 9A.

E_{F}=Σ|x(n)|² (Eq. 9A)

In Equation 9A, x is the singular value. The signal energy calculated (404) from the first and second LDVs at different time instants are denoted as E_{F1}(tᵢ), and E_{F2}(tᵢ), respectively, where i denotes the number of the time instant. The signal energy in the frequency range of interest obtained from the two LDVs E_{F1}(tᵢ) and E_{F2}(tᵢ) may then be smoothed (406) with a moving average filter (e.g., having a moving windows' length (in terms of the number of time instants) of 6, which is the number of time instants required for the measurement to move forward one rail span).

Next, at every time instant, the smoothed signal energy in the frequency range of interest obtained from the two LDVs (i.e., Ē_{F1}(t) and Ē_{F2}(t)) may be divided by the smoothed total energy from 0 to 30 kHz (i.e., Ē_{T1}(t) and Ē_{T2}(t)) to obtain the energy ratio (408). The energy ratio may be determined by Equation 9B.

Rⱼ(t)=Ē_{Fj}(t)/Ē_{Tj}(t) (Eq. 9B)

In Equation 9B, j denotes the number of LDV. The energy ratios for the first and second LDVs were denoted as R₁(t) and R₂(t), respectively. Next, the normalized energy ratios R_{norm,j}(t) may be obtained (410) by normalizing the energy ratio (R₁(t) and R₂(t),) by their maximum and minimum values separately, per Equation 9C.

$${R}_{norm , j} ( t ) = \frac{{R}_{j} ( t ) - min ( {R}_{j} )}{max ( {R}_{j} ) - min ( {R}_{j} )} \qquad ( Eq . 9 C )$$

Consequently, the damage function DF(t) may be determined (412) by calculating the multiplication of R_{norm,1}(t) and R_{norm,2}(t) per Equation 9D.

DF(t)=R_{norm,1}(t)*R_{norm,2}(t) (Eq. 9D)

Then, a distribution may be created using the points of DF(t) corresponding to the time instants in which the rail fasteners were all presented. The mean (μ) and covariance matrix (Σ) of the distribution may also be obtained. Next, the Mahalanobis distance (D_{M}(t)) between each point of DF(t) and the distribution [42] can be calculated per Equation 9E.

D_{M}(t)=(DF(t)−μ)^{T}Σ⁻¹(DF(t)−μ) (Eq. 9E)

Afterward, the D_{M}(t) may be normalized with respect to its maximum value to obtain the damage index (DI(t)). Then, to identify the rail segment that is affected by the missing fastener, a threshold may be placed (414) on DI(t). The threshold may be determined as two standard deviations from the sample mean. Consequently, the time instant with DI(t) values exceed the threshold would be considered as the time instant when the rail damage detection system passed through the rail section affected by the missing fastener.

### Example Joint Defect Detector

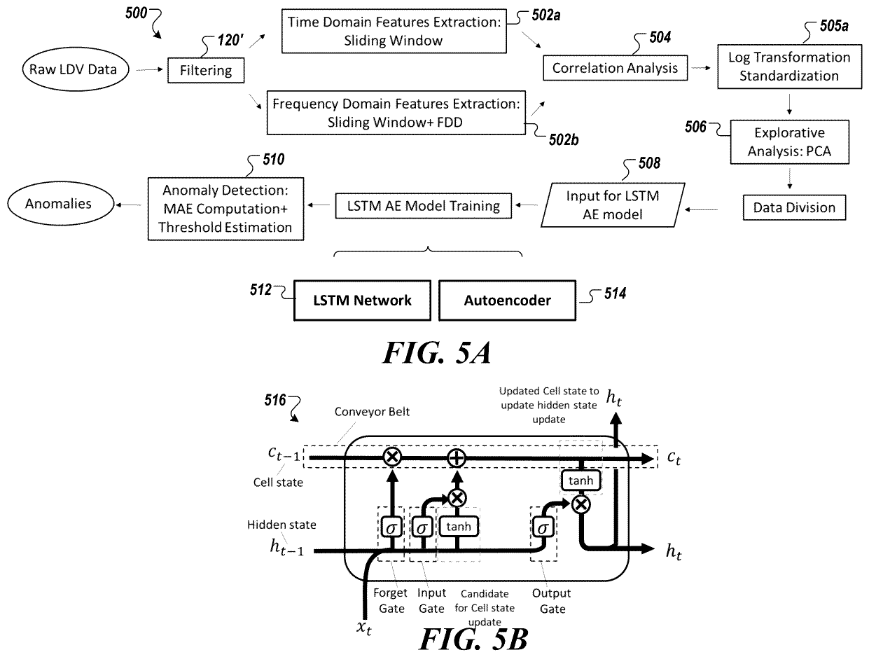

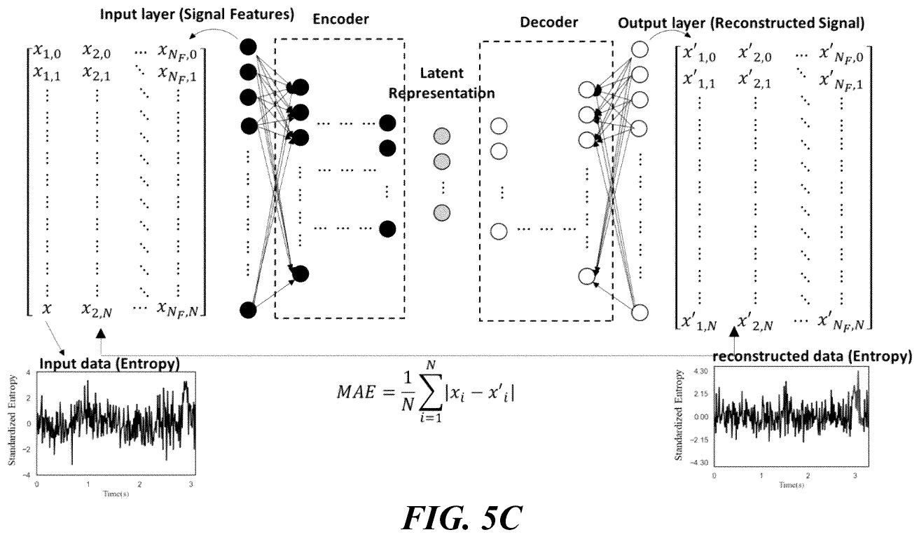

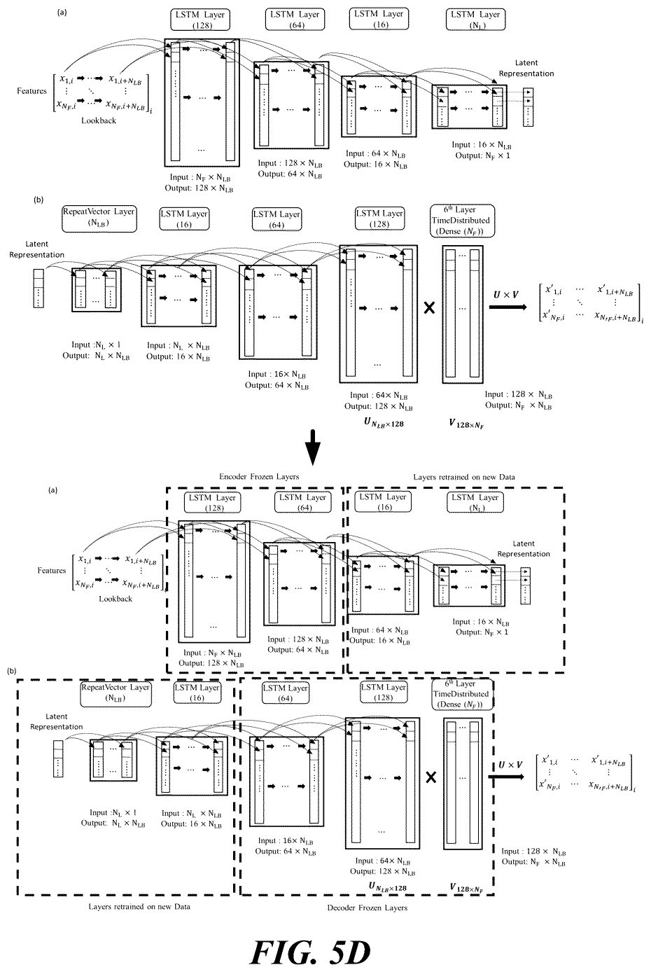

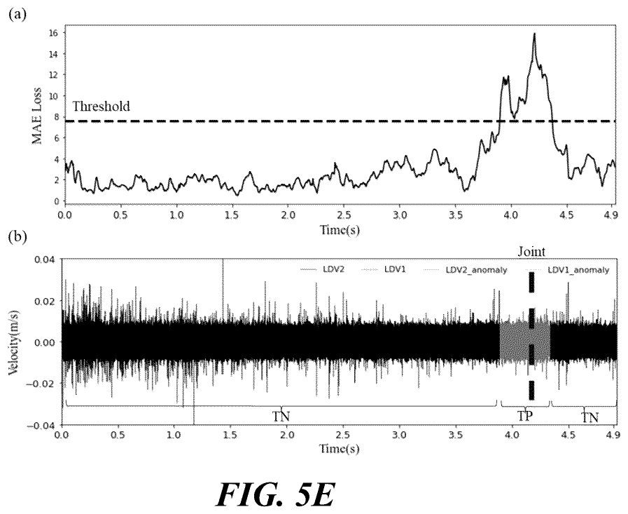

FIGS. 5A-5E show an example AI/ML joint detection module for detecting joint defects in a railway track in accordance with an illustrative embodiment.

FIG. 5A shows an example AI/ML joint detection operator 500. The AI/ML joint detection operator 500 is configured determine presence of a joint defect (or other defects) using LVD data. In the example shown in FIG. 5A, the AI/ML joint detection operator 500 is configured to perform filtering 120 (shown as 120″), feature calculation 502′, a trained AI model 511, and an anomaly detector 510 (shown as 510′). The runtime operation may employ similar pre-processing and trained AI/ML model as used in the training.

Training Operation. To train the AI/ML model 511, the training process 501 is configured to perform impulse noise filtering 120′ (previously shown as 120), and additionally other described herein, of the recorded LDV signals to eliminate impulsive noise. The training process 501 then extract features from a library of features to which a correlation analysis and principal components analysis are employed on the features for feature selection and dimension reduction.

The selected features are then utilized to train an LSTM autoencoder model for anomaly detection, specifically to identify the joint defects. It is noted that, while LDVs was recorded as the acquisition hardware passed over a joint defect, the exact duration of the joint's influence on the time-domain signal is unknown and labeled data distinguishing between normal and abnormal conditions are not available. This uncertainty is due to the measurements being conducted on a moving object, which included the defect's influence but did not specify the precise start and end points of the signals impacted by the defect.

Data Pre-Processing during Training. In FIG. 5A, the pre-processing pipeline during the training operation includes filtering 120″ of the time-domain LDV signals, as well as the transformation, and compression of the time-domain signal into a format suitable for the use with LSTM AE machine learning models through a series of steps. The steps included feature extraction (shown as 502a, 502b), correlation analysis (504), log transformation (505a), standardization, and principal component analysis (506).

Filtering. The LDV signal, e.g., as recorded by the LDV sensors (e.g., 102, 104), may exhibit a fluctuating non-zero mean and is susceptible to impulsive noise (IN). Both effects are amplified when the LDV is moving during the measurements. To ensure the high accuracy of the proposed damage detection methodology, the time-varying non-zero mean of the LDVs' signal may be eliminated by implementing a moving average filter [32] and the impulsive noise filter 120″. The impulsive noise filter can additionally mitigate the influence of impulsive noise on the signal and may include (i) identifying segments of the signal that contain IN (i.e., detection step), and (ii) estimating IN-free values by replacing those segments (i.e., estimation step) [16].

To mitigate the influence of IN, the impulsive noise filter may detect and replace contaminants comprising artificial peaks and artificial fluctuations. In the detection step, an algorithm based on Hampel Identifier [31], a robust outlier detection method, may be implemented to detect the artificial peaks, or that which is described in relation to FIG. 2A. A Stationary Wavelet Packet Transformation (SWPT) may be used to identify the artificial fluctuations. In the estimation operation, an algorithm based on constrained least squares may be used to replace the segments containing artificial peaks. In addition, the moving average filter, with Gaussian weights, is adopted to replace the segments containing artificial fluctuations. As a result, after the filtering of the LDVs data, the influence of impulsive noise was mitigated.

Features Extraction. To extract the features from the time series data, a sliding window method was applied. The sliding windows may convert continuous time series into sub-sequences or discrete sequences. A sliding window method may involve moving a window of a fixed size with a fixed time step along the signal in the direction of forwarding time. For each position, the values within a sliding window may be analyzed to transform the original time-series into a lower-dimensional representation, thereby reducing computational costs and enhancing calculation efficiency. The signals from two LDVs may be recorded at a sampling frequency of 1.25 MHz. The LDVs signals may be down-sampled to 62.5 kHz. Then, a low-pass filter may be applied to the signals with a cut-off frequency of 25 kHz.

Next, the sliding window may be applied. The determination of the window size may be based on the balance between the (i) calculation time to extract the features and (ii) the resolution of the data in both the time and frequency domain, and (iii) the minimum of two thousand data points for input to the neural network. For example, a sliding window with a size of 0.01 seconds and a time step of 0.001 seconds may be use for the test speed of 16 km/h (10 mph), a window size of 0.08 seconds and a time step of 0.0008 seconds may be used for the test speed of 32 km/h (20 mph), and a window size of 0.005 seconds and a time step of 0.0005 seconds may be used for the test speed of 48 km/h (30 mph).

Table 3 shows example features that may be extracted. In the example of Table 3, the feature are time based and feature based. Other types of features may be employed. In Table 3, features may be extractable from the two LDV data separately, including (i) Features in the time domain: maximum absolute value (SF1), peak-to-peak value (SF2), standard deviation (SF3), Kurtosis (SF4), root mean square (SF5), and Shannon's entropy (SF6), skewness (SF7), crest factor (SF8), shape factor (SF9), and (ii) Features in the frequency domain (in 0-25 kHz range): spectrum root mean square (SF10) and signal energy (SF11).

TABLE 3
Signal features and the corresponding formula
Time Domain Features

| | Maximum Absolute | | Standard Deviation |
|---|---|---|---|
| Features | Value (SF1) | Peak-to-Peak (SF2) | (SF3) |
| Equation | max(abs((L_{j,k}(n))) | max ((L_{j,k}(n)) − min ((L_{j,k}(n)) | $\sqrt{\frac{1}{N} {\sum }_{n = 1}^{N} {L}_{j , k} ( n ) - \overline{{L}_{j , k} ( n )}}$ |
| | | Root Mean Square | Shannon Entropy |
| Features | Kurtosis (SF4) | (SF5) | (SF6) |
| Equation | ${\sum }_{n = 1}^{N} \frac{{( {L}_{j , k} ( n ) - \overline{{L}_{j , k} ( n )} )}^{4} / N}{{{σ}_{j , k} ( n )}^{4}}$ | $\sqrt{\frac{1}{N} {\sum }_{n = 1}^{N} {{L}_{j , k} ( n )}^{2}}$ | ${\sum }_{n = 1}^{N} P ( {L}_{j , k} ( n ) ) * {log}_{2} ( P ( {L}_{j , k} ( n ) ) )$ |
| Features | Skewness (SF7) | crest factor (SF8) | Shape Factor (SF9) |
| Equation | ${\sum }_{n = 1}^{N} \frac{{( {L}_{j , k} ( n ) - \overline{{L}_{j , k} ( n )} )}^{3} / N}{{{σ}_{j , k} ( n )}^{3}}$ | $\frac{max ( \vert {L}_{j , k} ( n ) \vert )}{\sqrt{\frac{1}{N} {\sum }_{n = 1}^{n} {{L}_{j , k} ( n )}^{2}}}$ | $\frac{\sqrt{\frac{1}{N} {\sum }_{n = 1}^{n} {{L}_{j , k} ( n )}^{2}}}{\frac{1}{N} {\sum }_{n = 1}^{n} \vert {L}_{j , k} ( n ) \vert}$ |

Frequency Domain Features

| Features | Spectrum Root Mean Square (SF10) | Signal Energy (SF11) |
|---|---|---|
| Equation | $\sqrt{\frac{1}{Q} {\sum }_{q = 1}^{Q} {{F}_{j , k} ( q )}^{2}}$ | $\frac{{\sum }_{q = 0}^{Q - 1} {{F}_{j , k} ( q )}^{2}}{Q}$ |

In Table 3, the LDV signal is denoted as L_{j,k}(n), j=1,2 representing the number of the LDV, k is the number of the sliding window, where k=1, 2, 3, . . . k, and k is the total number of the sliding window. n denotes the number of the data point inside the window n=1, 2, . . . N, and N is the total number of data points in the window. σ_{j,k}(n) is the standard deviation of the j-th LDV signal in the n-th sliding window. For the entropy, P(L_{j,k}(n)) is the probability of the n-th value in the signal in the kth sliding window.

To obtain the frequency domain features, the frequency domain decomposition (FDD) is applied to the LDV signals. The FDD method can obtain the frequency spectrum. FDD is a non-parametric, output-only system identification method [33]. For every sliding window, the time domain data were analyzed using FDD, the singular values for the time domain signal in the sliding window could be obtained as: F_{j,k}(q), q=1, 2, . . . Q, where q is the number of the frequency bin and Q is the total number of frequency bins in the frequency range of interest.

Eventually, using the data collected from each LDV, eleven types of signal features could be extracted. For example, the SF1 obtained from the first LDV was denoted as SF1₁, while the SF1 obtained from the second LDV was denoted as SF1₂. In this study, two different LDVs were deployed with the purpose of examining their measurement performance (more details in section 4). Based on observations, given the higher signal-to-noise ratio of LDV2, two groups of signal features were utilized in training the neural network: (i) the signal features obtained from the LDV2 (e.g., SF1₂ to SF11₂), and (ii) the ratio of the two signal features SF1ᵣ to SF11ᵣ, which uses the signal features obtained from the LDV2 to be divided by those of LDV1 (e.g., SF1ᵣ=SF1₂/SF1₁). The ratio of signal feature provides a comparative measure, which can help in identifying anomalies. Therefore, a total number of twenty-two signal features (SF1₂ to SF11₂ and SF1ᵣ to SF11ᵣ) were extracted from the two LDV data.

LSTM AE Model. FIG. 5A shows an LSTM Autoencoder 511 having an LSTM network 512 and Autoencoder architecture 514. An LSTM network can operate by having memory cells and gates that regulate the flow of information into and out of the LSTM cells. FIG. 5B shows an example of the LSTM cell having an input (x_t), the previous hidden state (h_(t−1)),), and the previous memory cell state (c_(t−1)). The inputs may be passed to three different gates that manage the flow of information in the network: (i) the input gate, which regulates the flow of new information into the memory cell based on the current input and previous hidden state, (ii) the forget gate, which decides what information to forget by controlling the flow out of the memory cell, using the current input and previous hidden state, and (iii) the output gate, which controls the flow of information from the LSTM network to generate the final output, based on the current input, previous hidden state, and the memory cell's state. The gates may use sigmoid activation functions to produce values between 0 and 1, indicating the amount of information that can flow in and out of the memory cell. The gates can be considered analog switches that enable or restrict information to pass through based on their activation values. LSTM use this mechanism to store relevant information in a sequence and discard irrelevant information. The use of a LSTM cell enables the model to capture the temporal dependency in multivariate data.

The autoencoder may include an input layer, encoder, latent representation, decoder, and an output layer, as shown in FIG. 5C. The encoder can learn from the input data (X) to build the latent representation, while the decoder tries to reconstruct the data using the latent representation. Consequently, the reconstructed signal (X\hat{ }′) from the output layer may be used to compare with the input signal to obtain the loss function (i.e., Mean Absolute Error (MAE), which measures how well the output of the decoder matches the original input data. The neural network would be updated through iteration to minimize the MAE. The deep autoencoder can therefore be built by constructing multiple hidden layers in both the encoder and decoder

The data flow in the LSTM AE neural network may be performed in the pipeline in which the input data is a three-dimensional array in the form of Nₜ×N_{LB}×N_{F} where N_{LB} is the number of look back. The LSTM is configured to process data up to the previous N_{LB} time step for the current time step to make a prediction (N_{LB}=20). That is to say, when N_{LB}=20, the LSTM will consider the previous twenty time steps when making a prediction for the current time step.

For input data having the size N_{LB}×N_{F}, to encode the signal into the latent space, first, the input data may be passed into a first LSTM layer, e.g., with 128 hidden layers; each hidden layer may have the same number of the hidden cell of N_{LB}. In the first LSTM layer, each cell may emit a signal at every timestep (i.e., lookback) for the next LSTM layer. Each cell of the next layer in the same timestep may receive the signal from the cell in the previous layer. In the 2^{nd}, 3^{rd}, and the 4^{th} LSTM layer, there may be 64, 16 and N_{L} hidden layers, respectively, as an example. Only the last cell may emit the output to represent the latent space (1×N_{L}), where N_{L} is the number of dimensions of the latent space (N_{L}=3 in this study). To reconstruct the signal, the decoder is employed. The decoder layers may be arranged in a manner that is opposite to the order of the Encoder layers. First, the latent representation may be duplicated to transfer the 1D latent space to a two-dimensional array through the Repeat Vector layer. Then the 2D array may be inputted into three LSTM layers (with 16, 64, and 128 hidden layers, respectively), and outputs the data in the dimension of 128×N_{LB} (denotes as U_{N}_{_{LB×128}}). Next, the data may be passed into a TimeDistributed layer which can first produce a vector of length 128 and then duplicate it N_{F} times, resulting in an array with a dimension of 128×N_{F} (denotes as V_{128×N}_{_{F}}). Finally, a matrix multiplication may be conducted between U and V to generate a matrix with a dimension of N_{LB}×N_{F}, which is the reconstructed signal (i.e., X′).

Anomaly Detection. To perform anomaly detection, the reconstruction error based on MAE and the threshold may be computed. The reconstruction error is the difference between the reconstructed signal and the input signal measured from the intact rail segment. The reconstruction loss (i.e., eₓ_{ₜᵣₐᵢₙ}) may be calculated using the Mean Absolute Error (MAE) of the training model. Compared to Mean Square Error (MSE), MAE is suitable for data with a large range of values or for cases where the distribution is unknown or asymmetrical [34]. The MAE loss of the training model may be calculated per Equation 10A.

$${e}_{{x}_{train}} = \frac{1}{N} {\sum }_{i = 1}^{N} \vert {x}_{i} - {x}_{i}^{′} \vert \qquad ( Eq . 10 A )$$

In Equation 10A, xᵢ is the ith observed value and

$${x}_{i}^{′}$$

is the ith generated values given the input data

$$( i . e . , {x}_{i} ∈ X , {x}_{i}^{′} ∈ {X}^{′} ) .$$

Consequently, the threshold used for anomaly detection in this study could be obtained using Equation Set 10B.

$$Threshold = max ( {e}_{{x}_{train}} ) + 2 std ( {e}_{{x}_{train}} ) \qquad ( Eq . Set 10 B )$$

$${e}_{{X}_{Test}} = \{ \begin{matrix}1 , & {e}_{{x}_{i , test}} > Threshold \\ 0 , & {e}_{{x}_{i , test}} \leq Threshold\end{matrix}$$

If the reconstruction loss for a test point (i.e., eₓ_{_{i,test}}) is greater than the threshold (i.e., n_{threshold} times of the maximum training error), the data point would be marked as an anomaly. As a result, a function θ_{X}_{_{Test}} may be defined to return the outcome of the evaluation using Eq. Set 10B, where x_{i,test}∈Xₜₑₛₜ.

Machine Learning. In addition to the machine learning features described above, the analysis system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

A study was conducted to develop and evaluate impulsive noise filter, e.g., as described in relation to FIG. 2A. The study also developed a defect detector, e.g., as described in relation to FIG. 3. The study also developed a missing fastener detector, e.g., as described in relation to FIG. 4. The study also developed a joint detector, e.g., as described in relation to FIGS. 5A-5C using machine learning algorithms.

### A. Impulsive Noise Filter Development

The study carried out the evaluation of the filter's performance was carried out using a synthetic signal that consisted of a noise-free rail vibration signal in vertical direction induced by wheel/rail contact (i.e., vibration component) and a speckle noise signal of an LDV placed on a moving platform (i.e., noise component). Knowing these two components separately allowed for examination of IN in detail as well as the qualitative and quantitative assessment of the IN filter's performance. Examination of the speckle noise signal showed that IN manifests itself as artificial peaks, as well as higher-frequency noise in the proximity of the artificial peaks (i.e., artificial fluctuations). Accordingly, the developed filter incorporates two detection methods, one signal smoothing method, and one interpolation method. The first detection method (i.e., The Phase Space Thresholding) detects the segments containing an artificial peak, while the second detection method, developed specifically in this study, detects the segments containing both an artificial peak and fluctuations. Considering the difference in the segments detected by these methods, the segments containing artificial fluctuations were obtained. Afterward, the signal smoothing method (i.e., moving average filter with Gaussian weights) replaced the segments containing artificial fluctuations by reducing the higher frequency signal components causing the fluctuations. The interpolation method (i.e., Bilinear Interpolation) replaced the segments containing an artificial peak using autoregressive modeling. The qualitative and quantitative evaluation of the IN filter applied to the synthetic signal demonstrated that the filter was effective at mitigating IN.

The IN-filtered signals can be used in a wide range of different applications where system identification and wave propagation based approaches is used. For example, in a study where the damage detection is performed using signal amplitudes, the artificial fluctuations and the estimation performance of the filter might not be a concern. In such an application, the detection and estimation of artificial fluctuations can be removed from the IN filter, and the estimation of artificial peaks can be performed with a more straightforward interpolation method.

Synthetic LDV Signal. Consider a rail car instrumented with a LDV system, moving along a crosstie-supported rail, as shown in FIG. 2A, panel (a). The recorded LDV signal s(t) can be considered as a composition of the rail vibrations in the vertical direction induced by the wheel/rail contact v(t) (vibration component), and a speckle noise n(t) of an LDV placed on a moving platform (noise component) per Equation 1₁.

s(t)=v(t)+n(t) (11)

In order to create a synthetic signal s(t), field and laboratory tests were performed. Specifically, field tests were carried out to obtain the rail vertical vibrations component of the signal (see FIG. 2A, panel (b)) while an experimental set-up was designed in FSEL at UTA to simulate the speckle noise component.

The field tests were carried out on a railway track in Temple, TX, operated by BNSF Railway Corporation. Rail vibrations in the vertical direction were recorded during the passage of a rail car using an accelerometer (i.e., PCB 352A60) placed under the railhead (see FIG. 6A, panel (a)). The sampling frequency was set to 200 kHz. The estimated speed of the train was about 13 mph. Then, the recorded signal was integrated and filtered using a low-pass filter at 50 kHz for making it compatible with speckle noise signal (n(t)) for summation. Afterward, a segment of the signal corresponding to the passage between two wheels of a rail car was selected as v(t), as shown in FIG. 6A, panel (b). Any small segment of this signal, that could be recorded by an LDV placed at any particular point between two wheels, shows similar statistical (i.e., mean and standard deviation) and frequency characteristics. Therefore, this signal can be considered to represent a 0.6-seconds long rail vibration component.

The experimental set-up shown in FIG. 6B, panel (a) was designed to obtain the noise component. A steel beam 2000 mm long and 7.67 mm wide was used as a sample model of a rail. The thickness of the beam was 1.27 mm. The beam was supported at two ends using bolted connections and C-clamps. Four large I-beams served as supports raising the beam from the strong floor. No excitation was applied to the sample beam and the surface of the beam was very corroded. A scanning galvanometer mirror (SGM) was used to steer the laser beam of an infrared-based LDV (Polytec MLV-I-120). The scanning frequency of the mirror was set to 16.8 Hz, leading to approximately 13 mph translational speed of the laser beam on the test sample. The sampling frequency was set to 100 kHz due to the memory capacity of the data acquisition system, allowing to the recording of the speckle noise up to 50 KHz.

Since the signal did not exhibit a stationary zero-mean (due to the changes in the laser beam's moving direction during scanning), the polynomials were fitted to the different segments of the signal to obtain the moving mean. Afterward, the signal was subtracted from the moving mean to create a signal having zero mean. In addition, the recorded signal was interpolated to double the number of recorded signal points. The reason was to make this signal compatible with v(t) (Eq. 1) for summation since the sampling frequency of v(t) was 200 kHz. However, this procedure didn't increase the maximum frequency content of the signal (i.e., 50 kHz).

A 0.6-second-long speckle noise signal used as n(t) is shown in FIG. 6B, panel (b). A very short segment of n(t) is shown in FIG. 6B, panel (c) where multiple artificial peaks (APs) were observed in the recorded signal along with artificial fluctuations (AFs) in proximity of the peaks. Therefore, both artificial peaks and fluctuations were considered as IN in this study.

Finally, the synthetic signal (s(t)) was obtained using Eq. 1 (see FIG. 6C, panel (a). A small segment of s(t) along with v(t) is shown in FIG. 6C, panel (b). This figure shows that s(t) is corrupted by artificial peaks and fluctuations due to speckle noise. The figure also shows that the trend of s(t)'s segments containing artificial fluctuations is similar to v(t) at the corresponding segments.

The study implemented operation for the impulsive noise filter as described in relation to FIG. 2A. The study used (i) Phase Space Thresholding and (ii) Stationary Wavelet Package Transformation Thresholding, to detect segments containing an artificial peak and/or fluctuation (detection step). The study then used (iii) moving average filter with Gaussian weights and (iv) Bilinear Interpolation to replace the detected segments to estimate their IN-free values (estimation step).

Phase Space Thresholding [26], moving average filter with Gaussian weights [66] and Bilinear Interpolation [32] were selected from the literature while Stationary Wavelet Package Transformation Thresholding was specifically developed in this study since no methods, to the best of the inventor knowledge, were developed to detect artificial fluctuations. In addition, some steps were added to Phase Space Thresholding and Bilinear Interpolation to make these methods applicable to rail vibration measurements collected by an LDV placed on a moving platform.

In the design of the proposed filter, two main criteria were considered: (i) eliminating all the components of IN observed in the LDV signal (i.e., artificial peaks and fluctuations), and (ii) avoiding the use of parametric methods as much as possible to improve computational efficiency since the LDV signals can be very long in real applications. Therefore, only one parametric method (i.e., Bilinear Interpolation) was used in the filter to replace the segments containing artificial peaks. Implementation of the impulsive noise filter developed in the study are provided in relation to Tables 1A, 1B, and 1C.

Artificial Peak Detector. To detect the segments containing an artificial peak, an algorithm based on the phase-space thresholding method of Goring and Nikora [26] is proposed. The algorithm included steps 1A-1G per Table 1A.

TABLE 1A

| | |
|---|---|
| Step 1A. For a | Assume the sampling interval (i.e., Δt) of s(t) to be one second, |
| received signal, | regardless the actual value, in order to avoid numerical problems in the |
| determine a first and | subsequent steps [26]. Then, the first and the second derivative of s(t) |
| the second | may be calculated per Equation Set 1. In the equations, s(t₀), s(t_{N+1}), |
| derivative of the | \dot{s}(t₀) and \dot{s}(t_{N+1}) are considered to be zero. |
| received signal and | |
| generate a phase | The filter may then generate a phase space object of the received signal, |
| space object of the | the first derivative, and the second derivative. Fig. 6D shows a generated |
| received signal, the | phase place plot of s(t) vs. \dot{s}(t), \dot{s}(t) vs. \ddot{s}(t), and s(t) vs. \ddot{s}(t) (i.e., |
| first derivative, and | phase space plots) (see FIG. 6D, panels (a), (b), and (c)). [optional] |
| the second | |
| derivative | |
| Step 1B. Calculate | Calculate the standard deviation of s(t) and its derivatives (i.e., σₛ₍ₜ₎, |
| the standard | [symbol] , and [symbol] , respectively). Afterward, the universal thresholds for |
| deviation of the | s(t), \dot{s}(t) and \ddot{s}(t) are computed. The universal threshold for s(t) is |
| received signal and | Equation 2. The calculation of the universal thresholds for \dot{s}(t) and \ddot{s}(t) |
| derivatives; compute | (i.e., [symbol] and [symbol] , respectively) are also performed similarly. The goal |
| universal thresholds | of the universal threshold is to shrink a noisy signal to remove the noise |
| for the received | as much as possible while preserving the noise-free signal. More |
| signals and | information about the universal threshold can be found in [68]. |
| derivatives | |
| Step 1C. Compute | Using the universal thresholds, ellipsoids may be computed and placed |
| geometric shape | on the phase space plots as shown in FIG. 6D, panels (a), (b), and (c). |
| over phase space | The length of the minor and major axis (i.e., a and b, respectively) of |
| object based on the | the ellipsoids may be determined per: (i) a and b for the s(t) vs. \dot{s}(t) |
| universal threshold | phase space are λₛ₍ₜ₎ and [symbol] , respectively; (ii) a and b for the \dot{s}(t) vs. |
| | \ddot{s}(t) phase spaces are [symbol] and [symbol] , respectively; (iii) a and b for the |
| | s(t) vs. \ddot{s}(t) phase space may be calculated per Equation Set 3. |
| | In Equations 5 and 6, θ is the rotational angle of the ellipsoid (see FIG. |
| | 6D, panel (c)) which may be determined per Equation 3B. The ellipsoids |
| | placed on the other phase space plots do not exhibit a rotation. |
| Step 1D. Determine | The signal points located outside the ellipsoids are classified as signal |
| signal points outside | points corrupted by artificial peaks. Then, their values are replaced. |
| the computed | Afterward, the previous steps are repeated until no further points are |
| geometric shape | classified. Although this method requires the replacement of the |
| | detected signal points, the goal of this method in the proposed filter is |
| | only to detect signal segments containing an artificial peak. Therefore, a |
| | simple estimation method is used in this step to replace the detected |
| | signal points: At first, the length of one of the longest signal segments |
| | containing an artificial peak is determined in terms of signal points (i.e., |
| | [symbol] signal points). This is performed by visually examining s(t). Then, |
| | a signal window of length 2 [symbol] + 1 is placed on the first detected point. |
| | Next, this point is replaced by the median of the signal window. This |
| | approach is applied to the remaining detected points respectively to |
| | replace all the detected points. The reason for setting the length of the |
| | windows to 2 [symbol] + 1 is that, even though 50% of signal points in a |
| | segment are corrupted by outliers, the middle point of the segment can |
| | be replaced with the median to estimate its IN-free value [69]. A similar |
| | approach to determine the window length was also used in [58]. In this |
| | study, [symbol] was selected as 8 based on the examination of s(t). The next |
| | three steps were added in the proposed approach to enhance the detection |
| | performance and minimize false positives. |
| Step 1E. Grouping | The consecutive detected points may be grouped together as segments |
| consecutive detected | containing an artificial peak. Fig. 6D, panel D shows the percentage of |
| points as segments | the segments with respect to their lengths. |
| containing an | The maximum length of the segments containing 95% of all segments |
| artificial peak | can be denoted as N₉₅, and the maximum length of the segments |
| (optional) | containing 99% of all segments as N₉₉. If N₉₅ ≤ [symbol] ≤ N₉₉, the value of |
| | [symbol] is not changed, otherwise [symbol] is set to N₉₉. |
| | The study employed a bound of 95% and 99% so that (i) the window |
| | lengths can be suitable to the most of the segments while they are not |
| | chosen based on several segments whose lengths are too large, and (ii) |
| | the previous steps are not repeated for computational efficiency if the |
| | initial value of [symbol] is satisfactory. In the study, N₉₅ and N₉₉ were found |
| | to be 7 and 9, respectively. |
| Step 1F. Determine | $The minimum length of the correctly detected segmnts ( i . e . , {N}_{P}^{min} ) is$ |
| minimum length of | determined in terms of signal points. To achieve this, at first, the length |
| detected segment | of segments with the highest two percentages are found. If the length of |
| (optional) | the shorter segments is larger than the half-length of the longer segments, |
| | $the length of the shorter segment is considered as {N}_{P}^{min} . If not , the$ |
| | segments with the shorter length are disregarded. Then, the procedure is |
| | $applied to the remaining segments until {N}_{P}^{min} can be found . The$ |
| | motivation behind this step is that the examination of s(t) revealed that |
| | most of the segments containing an artificial peak have similar lengths. |
| | Therefore, it is unlikely to have such segments whose lengths are not |
| | $close to each other . Using this approach , {N}_{P}^{min} for s ( t ) was found to be$ |
| | 4 (see FIG. 6D, panel (d)). |
| Step 1G. Combine | $Next , the segments with a distance less than {N}_{P}^{min} signal points are$ |
| segments with a | combined. The goal is to obtain the segments containing an artificial |
| distance less than a | peak whose detection was corrupted by a small number of undetected |
| pre-defined signal | $signal points . Afterward , the segments whose length are less than {N}_{P}^{min}$ |
| point (optional) | are removed with the aim of minimizing false detection. |

Stationary Wavelet Package Decomposition Thresholding. The study obtained the signal segments containing the artificial fluctuations by subtracting the segments containing an artificial peak from the segments containing both an artificial peak and fluctuations. The latter was detected by a method developed in the study based on Stationary Wavelet Packet Transformation (i.e., SWPT) [38],[70]. The SWPT combines the attractive features of Stationary Wavelet Transformation (i.e., shift-invariance) and Discrete Wavelet Package Transformation (i.e., high-resolution decomposition) [71]. In literature, other methods based on wavelet transformation were also developed to detect IN [36,37]. The new method, be referred to hereinafter as the Stationary Wavelet Package Decomposition Thresholding, included steps outlined in Table 1B.

TABLE 1B

| | |
|---|---|
| Step. 1A. Compute | The SWPT spectrums of s(t) may be computed using a set of candidate |
| SWPT spectrums | mother wavelets, e.g., Symlet (e.g., with order between 2 and |
| | 6), Daubechies (e.g., with order between 2 and 6), and Coiflet (e.g., with |
| | order between 2 and 5). The candidate mother wavelets were selected |
| | based on the similarity of their shapes to the shape of artificial peaks and |
| | fluctuations observed in s(t). The higher-order Symlets and Daubechies |
| | wavelets were not considered since higher-order wavelets result in |
| | smearing of the detected IN to nearby signal points due to the |
| | multiplication of their long filter length with the signal. The |
| | decomposition level of the SWPT transformation required in the |
| | spectrums may be selected to make the resolution of the spectrums as |
| | close as to 2 kHz. This value may be determined to provide adequate |
| | resolution while minimizing the computational time. In the study, the 6^{th} |
| | level decomposition was used, which resulted in 64 frequency bins each |
| | having a frequency resolution of 1.5625 kHz. |
| | FIG. 6E, panel (a) shows one short segment of s(t). As an example, the |
| | corresponding SWPT spectrum which was computed using the 2^{nd} order |
| | Symlet wavelet is shown in FIG. 6E, panel (b). As this figure shows, the |
| | power of the segments containing IN is very high up to approximately |
| | 50 kHz, while the power of IN-free segments are high at lower |
| | frequencies. |
| Step. 1B. Obtain | The frequency, above which the power of the segments containing IN |
| frequencies, above | are higher than the power of IN-free segments (i.e., separating |
| which the power of | frequency), is obtained. |
| the segments | To achieve this, at first, the total power at each frequency bin up to the |
| containing IN are | maximum frequency content (which is 50 kHz for s(t) may be obtained |
| higher than the | for all 14 spectrums computed in Step 1A. FIG. 6E, panel (c) shows an |
| power of IN-free | example total power at each frequency bin (up to 50 kHz) of the SWPT |
| segments | spectrum that is shown in FIG. 6E, panel (b). |
| | Then, for all the spectrums, the frequency bin at which the behavior of |
| | total power changes (i.e., knee frequency) is obtained using the L-shape |
| | method [72]. This method is used to find the data point at which the trend |
| | of data changes (i.e., knee point). The method achieves this by fitting |
| | pairs of two lines to data points which are separated by each different |
| | data point. Then, the pair of two lines with minimum fitting error is |
| | found. The last data point of the first line is considered as the knee point. |
| | FIG. 6E, panel (c) shows also the application of the L-method. The knee |
| | frequency for this particular spectrum was found as 12.5 kHz since the |
| | 8^{th} frequency bin was determined as the knee point. |
| | Afterward, the separating frequency is obtained by calculating the |
| | average of all knee frequencies obtained from 14 different spectrums. |
| | The separating frequency for s(t) was found as 12.5 kHz. |
| Step. 1C. Determine | The order and type (i.e., approximation or detail) of SWPT's coefficients |
| the order and type of | which cover the region between the separating frequency and the |
| SWPT's coefficients | maximum frequency content the most (i.e., the decomposition |
| | coefficients) are determined. In this study, the decomposition |
| | coefficients were chosen as the 2^{nd} order detail coefficients since they |
| | cover the frequencies between 12.5 kHz and 50 kHz the most among |
| | other approximation and detail coefficients. The covered range is |
| | between 25 kHz and 50 kHz. |
| Step. 1D. Determine | The mother wavelet is determined. To achieve this, 14 different sets of |
| the mother wavelet | decomposition coefficients are obtained using the candidate mother |
| | $wavelets mentioned in Step 1 A ( {w}_{s ( t )}^{c} ) . Then , each set {w}_{s ( t )}^{c} is sorted in$ |
| | ascending order. Afterward, the mean of the wavelet coefficients |
| | $between the first 5 \% and 25 \% of each sorted {w}_{s ( t )}^{c} ( {μ}_{{s ( t )}_{\text{.15}}}^{c} ) is computed .$ |
| | In addition, the mean of the wavelet coefficients between the first 25% |
| | $and 75 \% of each sorted {w}_{s ( t )}^{c} ( {μ}_{{s ( t )}_{\text{.50}}}^{c} ) , and between the first 75 \% and$ |
| | $95 \% of each sorted {w}_{s ( t )}^{c} ( {μ}_{{s ( t )}_{\text{.85}}}^{c} ) are calculated . The wavelet which$ |
| | results in the maximization of the Equation 4 selected as the mother |
| | wavelet. |
| | Eq. 4 maximizes the difference between the segments containing IN |
| | $( represented by {μ}_{{s ( t )}_{\text{.15}}}^{c} and {μ}_{{s ( t )}_{\text{.85}}}^{c} ) and the IN - free segments$ |
| | $( represented by {μ}_{{s ( t )}_{\text{.50}}}^{c} ) . However , it excludes the highest and lowest$ |
| | $values of {w}_{s ( t )}^{c} since they represent the largest artificial peaks .$ |
| | Consequently, the effect of segments containing artificial fluctuations |
| | $are not reduced in the calculation of {μ}_{{s ( t )}_{\text{.15}}}^{c} and {μ}_{{s ( t )}_{\text{.85}}}^{c} . For s ( t ) , the$ |
| | mother wavelet is found to be the 5^{th} order Symlet wavelet. FIG. 6F, |
| | panel (a) shows s(t) along with the decomposition coefficients of s(t) |
| | which was obtained using the selected mother wavelet (i.e. wₛ₍ₜ₎). As the |
| | figure shows, the difference between the IN-free segments and the |
| | segments containing an artificial peak and fluctuations were magnified. |
| | The first four steps find the mother wavelet and the frequency range of |
| | interest. It may not be necessary to re-apply these steps to new signals if |
| | the shape of IN and frequency characteristics of rail vibrations are |
| | similar to the ones demonstrated in this study. The next three steps are |
| | used to obtain signal segments containing an artificial peak and |
| | fluctuations. |
| Step. 1E. Determine | The second-order difference of wₛ₍ₜ₎ may be obtained per Equation 5. |
| the second-order | In Equation 5, Δ is the difference in the consecutive wₛ₍ₜ₎ points [73]. |
| difference | Using the minus sign before Δwₛ₍ₜ₎ allows the sign of local minimums |
| | and maximums of s(t) to be kept the same as the sign of local minimums |
| | and maximums of Δ²wₛ₍ₜ₎. Zeros may be added at the beginning and end |
| | of Δ(−Δwₛ₍ₜ₎) since the second order difference results in decreasing the |
| | number of coefficients by 2. The goal of this step is to further amplify |
| | the difference between the IN-free segments and the segments |
| | containing an artificial peak and fluctuations, as shown in FIG. 6F, panel |
| | (b). Additional description may be found in [26]. |
| Step. 1F. Determine | The envelope of \|Δ²wₛ₍ₜ₎\| (E_{\|Δ}_{²}_{ws(t)\|}) is calculated. This is achieved by |
| the envelope of | using the maximum value in the moving windows of \|Δ²wₛ₍ₜ₎\|. The |
| \|Δ²wₛ₍ₜ₎\|(E_{\|Δ}_{²}_{ws(t)}\| | moving window length is selected based on the dominant distance |
| | between the peaks of \|Δ²wₛ₍ₜ₎\|, which is three signal points for Δ²wₛ₍ₜ₎. |
| | Then, the threshold (i.e., Wthr) is calculated using the median of |
| | \|Δ2wₛ₍ₜ₎\|. FIG. 6F, panel (c) shows \|Δ²wₛ₍ₜ₎\|, E_{\|Δ}_{²}_{ws(t)\|} and Wthr. Next, |
| | the points of \|Δ²wₛ₍ₜ₎\| exceeding Wthr are classified as the signal points |
| | containing an artificial peak and fluctuations. |
| | The reason for calculating the threshold using the median is that almost |
| | half of \|Δ²wₛ₍ₜ₎\| exhibited very large peaks due to amplification of |
| | segments containing IN. These large peaks can be considered as outliers |
| | and the median computes the center point of a distribution without being |
| | affected by outliers [69]. |
| Step. 1G. Cluster | The consecutive detected points are clustered as segments containing an |
| the consecutive | artificial peak and fluctuations. Then, the difference between such |
| detected points as | segments and the segments containing an artificial peak (found using |
| segments containing | Phase Space Thresholding) are used to obtain the segments containing |
| an artificial peak and | artificial fluctuations. Afterward, the segments that are not adjacent to a |
| fluctuations | segment containing an artificial peak are removed to minimize false |
| | detection. This because it was observed that artificial fluctuations appear |
| | in the proximity of artificial peaks. |

Replacement of Artificial Fluctuations. Segments containing artificial fluctuations (e.g., 209) can result from an increase in the frequency of the speckle noise in the proximity of the artificial peaks. Accordingly, it can be observed that the trend of such segments is similar to the shape of the corresponding segments in v(t) (see FIG. 6A, panel (b)). In the IN filter developed in the study, a moving average filter with Gaussian weights, which is a signal smoothing method (e.g., 210), is used to replace the segments containing artificial fluctuations. The reason for selecting this filter is that this filter can decrease the power at high frequencies while not completely removing them since its cut-off frequency exhibit a smooth shape [66]. To demonstrate the use of this method, consider a segment of s(t) containing artificial fluctuations that is located between s(t_{A}) to s(t_{B}) as shown in FIG. 6A, panel (b). The values of the segment may be replaced per Equation 7

If the filter length is odd, s(t_{A+n}) is centered in the middle of the moving window. The moving window length (k) may be set to 8 if N_{f}≥8. Given the sampling frequency of s(t), 8-signal points long filter can create a smooth decay in the frequency response of the filter, reducing the power more as the frequency increases, while not completely removing them. 8 signal points was observed to be the optimum filter length for s(t). If N_{f}≤8, k is set to N_{f}. If another sampling frequency was used for the LDV signal, it is suggested to multiply 8 with the ratio of the new sampling frequency and the sampling frequency of s(t) (200 kHz), and then round the calculated number to nearest integer to find the optimum filter length. When all detected segments containing artificial fluctuations are replaced, s(t) with filtered artificial fluctuations (s̅(t)) is obtained.

Replacement of Artificial Peaks Using Bilinear Interpolation. The study implemented an algorithm based on Bilinear Interpolation [32] in the last stage of the IN filter to replace segments containing an artificial peak. This method originates from [74] where the missing signal points were estimated statistically in multivariate time series. It was then adopted in [32] to estimate IN-free values of corrupted audio signals. However, since Bilinear Interpolation uses autoregressive modeling, this method can be applied only to the signals that exhibit local stationarity. Local stationary behavior of signals was exploited in [29], [31], [34] as well to replace segments containing IN. The study determined that signals of the LDV exhibit local stationary behavior.

Bilinear Interpolation is implemented using three different approaches [32] in the study: forward linear prediction, backward linear prediction, and their combination. Forward linear prediction based approach replaces the segments by interpolating the IN-free segments located at two sides of the replaces segment (see FIG. 6G, panel (a)). The interpolation is performed using autoregressive modeling whose parameters are determined from the IN-free segment located before the replaced segment. This is because the length of this segment is suitable to estimate local signal parameters. FIG. 6G, panel (b) shows the backward approach which is the reverse of the forward approach and FIG. 6G, panel (c) shows the approach that combined forward and linear prediction based approaches.

To demonstrate the application of the forward linear prediction based approach on s̅(t), the study considered: (i) an N_{P} signal points-long segment containing an artificial peak starting from s̅(t_{E}) and ending at s̅(t_{F}), as shown in FIG. 6A, (ii) an N_{B} signal points-long IN-free segment located before s̅(t_{E}) (from s̅(t_{D}) to s̅(t_{E-1})), and (iii) an N_{A} signal point long-IN-free segment located after s̅(t_{F}) (from s̅(t_{F+1}) to s̅(t_{G})). The letters D, E, F, and G represents the integers indicating the order of the sampled signal points. FIG. 6H, panel (a) shows the representative view of the three segments. To replace the segment containing the artificial peak, this approach estimates the IN-free values of signal points in that segment using the preceding r number of signal points. In addition, this approach also estimates the values of the signal points in the second IN-free segment using the preceding r number of signal points (see FIG. 6H, panel (a)). However, the actual values of signal points in the second IN-free segment are actually known. Consequently, the IN-free segments located at both sides of the segment containing the artificial peak are considered in the replacement of this segment, which is carried out based on the minimization in the mean-square sense per Equation 8.

$$\{ \overline{s} ( {t}_{E} ) , … , \overline{s} ( {t}_{F} ) \} = {arg min}_{\overline{s} ( {t}_{E} ) , … , \overline{s} ( {t}_{F} )} {\sum }_{j = 0}^{{N}_{P} + r - 1} {[ \overline{s} ( {t}_{E + j} ) - {\sum }_{k = 1}^{r} {φ}_{k} \overline{s} ( {t}_{E + j - k} ) ]}^{2} = {arg min}_{{ψ}_{e}} {ψ}^{T} {B}^{T} B ψ \qquad ( 11 )$$

In Equation 11, φ is the vector of autoregressive model coefficients, r is the order of autoregressive model, ψ is the vector of signal points used in estimation (i.e., ψ=[s̅(t_{E-r}), . . . , s̅(t_{F+r})]^{T}), ψₑ is the vector of the replaced segment, and B is a (r+N_{P}) by (2r+N_{P}) matrix. The matrix B consists of the elements of φ. When all detected segments containing artificial peaks are replaced, IN filtered s(t) (s̅(t)_{IN}) is obtained.

In this study, the lower limit of N_{B} was chosen to be 2N_{P}, and it was determined due to the facts that: (i) the r number of φₖ are found through Ordinary Least Squares method using 2r number of signal points in the IN-free signal segment located before the segment containing the artificial peak [75], and (ii) the value of r should not be lower than N_{P} to keep the estimation performance high. The upper limit of N_{B} was chosen as 4N_{P} so that r is not much larger than N_{B}. Consequently, the effect of the estimated values in the segment containing the artificial peak on the estimation of signal points succeeding the segment is not reduced (see Eq. 11 and FIG. 6H, panel (a)).

The lower limit of N_{A} was chosen as N_{P} to have minimum N_{P} signal points available after the segment containing the artificial peak. This condition is required for Bilinear Interpolation [32]. The upper limit of N_{A} was determined as 2N_{P} so that only the IN-free segment located before the segment containing artificial peak can be used to determine φ, and the estimation is performed only from left to right (see FIG. 6H, panel (a)).

The value of r is chosen as follows with the aim of making its value as large as possible per Equation 7B. In the approach based on backward prediction method (see FIG. 6H, panel (b)), the lower and upper bounds for the length of the IN-free segments may be located before and after the segment containing an artificial peak are N_{P} and 2N_{P}, and 2N_{P} and 4N_{P}, respectively. In this case, r is found by switching the location of N_{A} and N_{B} in Equation 7B.

The approach combining the forward and backward linear prediction may calculate the weighted sum of the IN-free signal points which are estimated by these a. These weights were calculated based on the local predictive performance in some studies [32,35]. However, the weights were simply considered to be 0.5 in the present study as this simple approach led to good estimation performance. In order to apply the combined approach, the lower and upper bounds for the length of the IN-free segments located before and after the segment containing an artificial peak should be 2N_{P} and 4N_{P}, respectively. The value of r is chosen as the larger value of N_{B}/2 and N_{A}/2.

For Bilinear Interpolation to perform efficiently, r should be smaller than or equal to the maximum order of the model (i.e., r_{M}). The maximum model order is the number of subsequent signal points after a given signal point with a high level of correlation with the given signal point. The higher the model order, the more segments with larger lengths that contain an artificial peak can be estimated reliably. The value of r_{M} for s(t) was determined as 10 in the study, indicating that Bilinear Interpolation presented herein can be applied to the segments with a maximum length of 10 signal points. However, less than 1% of the segments containing an artificial peak have a length larger than 10 signal points (see section 3.1), Therefore, to replace such segments, this study introduces the maximum allowable model order (i.e. r_{MA}). This model order is the number of subsequent signal points located after a given point in which more than half of the subsequent signal points demonstrate a high level of correlation with the given point. The value of r_{MA} for s(t) was determined as 44, which is lower than the maximum length of segments containing an artificial peak (i.e., 22).

Table 1C shows example operations for a Bilinear Interpolation as developed in the study.

TABLE 1C

| | |
|---|---|
| Replace segments | At first, Bilinear Interpolation is applied to replace the shortest |
| containing an | segments containing an artificial peak (i.e., segments with a length of |
| artificial peak | ${N}_{P}^{min} signal points as determined in prior operation ) . Then , IN - free$ |
| starting with the | segments are regrouped considering that the replaced segments are IN- |
| shorter to the longest | free. Next, this procedure is applied to replace the second shortest |
| | segments containing an artificial peak. Afterward, the IN-free segments |
| | are regrouped again. This procedure is repeated until Bilinear |
| | Interpolation is applied to all the segments with different lengths that |
| | contain an artificial peak, respectively. However, Bilinear Interpolation |
| | might not be applied to some segments due to IN-free segments located |
| | at both sides of these segments having less than 2N_{P} signal points. |
| Aggregate remaining | If any segments containing an artificial peak remain at the end of the |
| segment having a | previous step, the segments whose distance are less than or equal to |
| distance less than | ${N}_{P}^{min} signal points are combined . Then , these segments are replaced by$ |
| ${N}_{P}^{min} signal points$ | re-applying Step 1. If there are still any segments containing an artificial |
| | peak left, the minimum length restriction for the shorter IN-free |
| | segments located before or after the segments containing an artificial |
| | peak (2N_{P}) is removed. This causes the value of r to be smaller than |
| | N_{P}, leading to lower estimation performance. |

The study contemplated that the developed algorithm can be applied on any rail vibration signals recorded by an LDV placed on a rail car traveling approximately 13 mph. This is because the length of segments containing an artificial peak depends on the speckle noise component of such signals. This component is expected not to be more severe than the noise component considered in this study, which was obtained from a very corroded surface. Consequently, most of the segments containing an artificial peak can be replaced using the maximum model order (i.e., r_{M}) and the first two steps of the algorithm.

Motivation. Two methods (Phase Space Thresholding and Stationary Wavelet Package Transformation Thresholding) were used in the study for the detection of segments containing an artificial peak and/or fluctuation (detection step) while other two methods (moving average filter with Gaussian weights and Bilinear Interpolation) are used to replace the detected segments to estimate their IN-free values (estimation step). Phase Space Thresholding [26], moving average filter with Gaussian weights [66] and Bilinear Interpolation [32] were selected from the literature while Stationary Wavelet Package Transformation Thresholding was specifically developed in this study since no methods, to the best of the authors' knowledge, were developed to detect artificial fluctuations. In addition, some steps were added to Phase Space Thresholding and Bilinear Interpolation to make these methods applicable to rail vibration measurements collected by an LDV placed on a moving platform.

In the design of the IN filter, two main criteria were considered in the study: (i) eliminating all the components of IN observed in the LDV signal (i.e., artificial peaks and fluctuations), and (ii) avoiding the use of parametric methods as much as possible to improve computational efficiency since the LDV signals can be very long in real applications. Only one parametric method (i.e., Bilinear Interpolation) was used in the filter to replace the segments containing artificial peaks. Table 2 outlines the rationale for the selection of the IN filter components in the study.

TABLE 2

| IN Filter Subpart | Rationale for development |
|---|---|
| Phase Space | The study selected Phase Space Threshold Method to detect artificial |
| Threshold Method | peaks since (i) this method is a time-domain method and detecting solely |
| | such peaks using frequency-domain approaches could not be efficient |
| | since the frequency content of such peaks are similar to the ones of |
| | artificial fluctuations, (ii) it was also stated in the literature that use of |
| | time-domain approaches could be more efficient for the detection of IN |
| | [67], (iii) it is not a parametric method, favoring computational |
| | efficiency. (iv) it was initially developed to detect IN observed in LDV |
| | measurements, and (v) it demonstrated very good performance, finding |
| | the entire portion of artificial peaks from their initiation point to end |
| | point. The use of filters that are easy to implement, such as the detection |
| | step of Hampel Filter which uses Median filter was avoided since they |
| | could only detect a portion of the artificial peaks due to implementing |
| | thresholds [58]. |
| Moving average | The study selected Moving average Filter with Gaussian weights to |
| Filter with Gaussian | replace artificial fluctuations since it is capable of reducing high |
| weights | frequency noise through its smooth cut-off behavior [66]. |
| Bilinear | Bilinear Interpolation was selected to replace artificial peaks since (i) it |
| Interpolation | replaces such peaks using a parametric model so that the signal |
| | parameters of the replaced segments can be estimated as close as |
| | possible to the parameters of the corresponding IN-free segments, |
| | maximizing the estimation performance of the filter, (ii) IN-free values |
| | at both sides of the replaced segments are taken into consideration to |
| | maintain the smoothness of the replaced segment, (iii) it is applied |
| | locally to the replaced segments, hence favoring the computational |
| | efficiency, (iv) it demonstrated good convergence performance in terms |
| | of estimating the signal parameters compared to another method which |
| | has similar features as Bilinear Interpolation (i.e., Expectation |
| | Maximization with Data Augmentation using autoregressive modeling |
| | [64]). The use of signal smoothing using a Median filter was avoided in |
| | this step since it is likely to perform poor estimation performance when |
| | it is applied to one-dimensional signals [67]. |

Results and Validation. The study carried out both qualitatively and quantitatively using the IN-free rail vibration signal component and the IN-corrupted speckle noise component. [30], [35], [40], [41], [59]. Validation of IN filters' performance using signal components were also performed in different studies as well [30], [35] [, [40], [41], [59]. For qualitative evaluation, the study choose virtual assessment as an easy and efficient way to investigate qualitatively the filter's capability to suppress IN.

The study performed visual evaluation of the analysis. The study also quantitatively evaluation of the filter based on impulsiveness reduction rate (IRR) and average correlation coefficient (ACC). These measures were designed to evaluate the performance of the detection and estimation steps of the proposed filter, respectively.

To calculate IRR, the alpha parameter (i.e., a) of alpha-stable distribution was used since this parameter is capable of quantifying the impulsiveness of a signal [76]. The lower and upper bounds of a are 1 and 2, respectively. Lower values indicate higher impulsiveness while the upper limit indicates Gaussian distribution with no impulsiveness. IRR was used because impulsiveness of the synthetic signal can decrease as more segments containing IN are detected and replaced. It can be considered that the performance of IN detection increases as the impulsiveness of the synthetic signal decreases, or IRR increases. To calculate IRR, v(t) was used as

$$IRR = \frac{{a}_{{\overline{s} ( t )}_{IN}} - {a}_{s ( t )}}{{a}_{v ( t )} - {a}_{s ( t )}} \times 100 \% ,$$

where aₛ₍ₜ₎ is the a parameter of s(t), a_{s̅(t)}_{_{IN}} is the a parameter of s̅(t)_{IN}, and aᵥ₍ₜ₎ is the a parameter of v(t). In this study, aₛ₍ₜ₎ is 1.51, aᵥ₍ₜ₎ is 1.95, and a_{s̅(t)}_{_{IN}} was found to be 1.83. Accordingly, IRR was calculated as 73%, indicating that the filter decreased the impulsiveness of s(t) notably by detecting a considerable amount of IN.

The study used ACC to evaluate the estimation step of the filter. This measure was developed based on the fact that the filter's estimation performance increases as the replaced segments become more similar to the corresponding segments in v(t). The ACC was calculated as

$$ACC = \frac{{ρ}_{IN}}{{ρ}_{\overline{IN}}} = \frac{\frac{1}{{N}_{IN}} {\sum }_{i = 1}^{{N}_{IN}} \vert {ρ}_{{IN}_{i}} \vert}{\frac{1}{{N}_{\overline{IN}}} {\sum }_{i = 1}^{{N}_{\overline{IN}}} \vert {ρ}_{{\overline{IN}}_{i}} \vert} ,$$

where ρ_{IN}_{ᵢ} is the correlation coefficient between a replaced segment of s(t) and the corresponding segment in v(t), N_{IN} is the number of segments containing IN, ρ_{I̅N̅}_{ᵢ} is the correlation coefficient between an IN-free segment of s(t) and the corresponding segment in v(t), and N_{I̅N̅} is the number of IN-free segments. In the ACC, the average of ρ_{IN}_{ᵢ}'s and ρ_{IN}_{ᵢ}'s equal to ρ_{IN} and ρ_{I̅N̅}, respectively. The upper bound of ACC is 1, and it indicates the best estimation performance. The reason for normalizing ρ_{IN} with ρ_{I̅N̅} is that even ρ_{I̅N̅} can not be one due to noise in IN-free segments of s(t) (see FIG. 6B, panel (c) and FIG. 6C, panel (b)). The value of ACC was calculated as 0.92, indicating that the replaced segments exhibited a high degree of similarity to the corresponding segments of v(t).

Overall, considering the facts that (i) s(t) is highly corrupted by IN, and (ii) the segments containing an artificial peak were replaced using the IN-free segments located around them which still consisted of broadband noise due to speckle noise, the performance of the proposed filter was considered efficient.

### B. Railway Damage Detection

Experimental Tests. The study carried out field tests on the High Tonnage Loop (HTL) at TTC. The HTL was divided into test sections, as shown in FIG. 7A, panel (a). The test track section was located in section 36 (see FIG. 7A, panel (b)). The rail profile consists of 136 lb. (61.68 kg) A.R.E.A (The American Railway Engineering Association) with spacing between the sleepers equal to 0.52 m. In order to simulate a transverse rail defect, a welded rail joint was identified in the test section, which was approximately 22 meters long. Welded joints act like scatters once they interact with the propagating waves and have been used in other studies to simulate internal defects in rails [26′].

In the tests, rail vibrations and propagating waves induced by wheel-rail interaction forces caused by a moving rail car were measured by: 1) accelerometers placed under the railhead, and 2) the LDV based-noncontact proposed damage detection system installed on a rail car, as shown in FIG. 7A, panel (c). In both kinds of tests, the measurements of rail were carried out with the rail car moving at three different speeds: 16 km/h (10 mph), 32 km/h (20 mph), and 48 km/h (30 mph). Accordingly, three LDV and accelerometer datasets were collected. An overview of the experimental set-ups is shown in FIG. 7B.

In the accelerometer measurements (see FIG. 7B, panel (a)), a 49 cm long rail segment with a welded joint was instrumented with an array of eight accelerometers (PCB 352C65) equally spaced (i.e., 7 cm) under the railhead. The accelerometers were connected to a data acquisition system (Dewesoft XHS) and the sampling frequency was set to 375 kHz. The signals were collected during the passage of the rail car over the instrumented section at all test speeds.

The instrumentation configuration of the damage detection system which carried out the LDV measurements is shown in FIG. 7B, panel (b). The reason for placing the LDVs in front of the rail car in this system was to record the waves propagating only in one direction since wheel-rail interaction induces waves that propagate in two directions [25′]. Each LDV was connected to a holder frame through four vibration isolators (Soitec MP28-58I) in order to minimize the vibrations of LDVs during the tests. The lift-off distance between the LDVs and the top rail surface was 105 cm, and the distance between the center of the LDVs was 40 cm. The lift-off distance was determined by considering that: (i) a higher lift-off distance leads to less speckle noise due to increasing the laser beam's spot diameter [27′], [28′] and (ii) the increased lateral vibrations of LDVs at high test speeds do not cause the LDVs' laser beams to deviate from the top rail surface. The distance between the center of the LDVs was determined based on the fact that (i) the holder was designed to allow for distances between LDVs ranging from 20 cm to 60 cm with 10 cm increments, and (ii) the average distance was chosen in this initial field testing of the system. Moreover, two different LDVs were used in the damage detection system with the purpose of examining their measurement performance. The first LDV (LDV #1 in FIG. 7B, panel (b)) was a single-beam Polytec Vibroflex Xtra MLV-I-120, and the second LDV (LDV #2 in FIG. 7B, panel (b)) was a tri-beam Polytec MLV100 Xtra. Both LDVs operate using infrared light technology. A better signal-to-noise ratio was expected using the MLV100 Xtra since its measurements are enhanced using three laser beams. The sampling frequency was set to 1.25 MHz. The reason for using higher sampling frequency in LDV measurements was to obtain smoother signals in the frequency range of interest for noise reduction and damage detection algorithms.

Results of Accelerometer Measurements. Measurements obtained by an accelerometer (A7). The acceleration signal, which was recorded when the rail car was traveling at 32 km/h (20 mph) at different time instants. The signal was bandpass filtered between 30 kHz and 100 kHz (i.e., the frequency range of interest), in order to detect the waves propagating in the railhead.

To quantify the change in the amplitude of these waves due to their interaction with the joint, a moving sample standard deviation was computed using a sliding window of 500 signal points. The window length was selected to balance between (i) smoothing the moving standard deviation to clearly obtain the main trend of the change in the accelerometer signal's amplitude while (ii) still capturing the sudden spikes in the signal.

Result of Pre-processing. To demonstrate that the pre-processing stage of the damage detection system is capable of identifying the changes in the recorded LDV signals due to a defect located in rail head (i.e., discontinuity in rail head) before, during, and after the passage of the damage detection system over the defect, FIG. 7C shows the variations of the normalized σ̅_{L̅}_{₁}(t) and σ̅_{L̅}_{₂}(t) at different time instants corresponding to the different locations of the LDVs over the rail (i.e., t₁, t₂, t₃, t₄, t₅, t₆, t₇, t₈). These time instants were selected to represent the specific instants when different behaviors were observed in σ̅_{L̅}_{₁}(t) and σ̅_{L̅}_{₂}(t). The normalization of σ̅_{L̅}_{₁}(t) and σ̅_{L̅}_{₂}(t) was carried out by dividing them with the mean of their values between t₁ and t₂. Herein, the different behaviors of the normalized σ̅_{L̅}_{₁}(t) and σ̅_{L̅}_{₂}(t) between particular time instants can be explained with the support of findings from the accelerometer tests as follows:

Between t₁ and t₂; when the defect detection system was located away from the representative defect, it can be observed that both σ̅_{L̅}_{₁}(t) and σ̅_{L̅}_{₂}(t) exhibited a plateau.

Between t₂ and t₄; when the LDVs were approaching the defect, an increasing trend both in σ̅_{L̅}_{₁}(t) and σ̅_{L̅}_{₂}(t) was observed in the proximity of the joint. In particular, σ̅_{L̅}_{₁}(t) reached the highest value of its local increase at t₃, while σ̅_{L̅}_{₂} (t) reached its highest value of its local increase at t₄. Such changes in the standard deviations were due to the fact that some portion of waves were reflected from the defect. A decreasing trend was observed only in σ̅_{L̅}_{₁} (t) between t₃ and t₄. This is because (i) the first LDV was located behind the joint (with respect to +x direction) after t₃, and (ii) less portion of waves were transmitted to the other side of the defect.

Between t₄ and t₆; as LDVs moved away from the defect while wheels were still located behind the joint, both σ̅_{L̅}_{₁}(t) and σ̅_{L̅}_{₂} (t) decreased due to the less amount of transmitted waves. However, there was an increase in σ̅_{L̅}_{₂} (t) at t₅, which might be attributed to peaks observed between t₁ and t₂ in FIG. 7C, panel (d).

Between t₇ and t₇; when the first two wheels passed over the joint, respectively, a small sudden increase in σ̅_{L̅}_{₁} (t) was observed at t₆ while a small increase in σ̅_{L̅}_{₂} (t) was observed at the t₆. In addition, some increases in σ̅_{L̅}_{₁}(t) and σ̅_{L̅}_{₂}(t) at time instants close to t₇ were observed, which might be correlated with the increase observed at t₃ in FIG. 7C, panel (d).

At t₈; when the first and second wheels traveled a bit more behind the joint, a sudden increase in σ̅_{L̅}_{₂}(t) was observed. This might be attributed to (i) the peak observed at t₅ in FIG. 7C, panel (d), and (ii) the fact that the second LDV captured this sudden behavior better since its signal-to-noise ratio is higher than the first LDV.

Accordingly, the particular values of t₃, t₄, t₅, t₆, t₇ and t₈ in FIG. 7C, panel (b) were identified as 1.474 s, 1.494 s, 1.645 s, 1.794 s, 2.079 s, and 2.148 s, respectively. The difference between t₃ and t₄ equals to the exact time required for the rail car to travel the distance between LDVs, the difference between t₄ and t₆ equals to the exact time required for the rail car to travel the distance between the second LDV and the first wheel, and the difference between t₆ and t₇ equal to the exact time required for the rail car to travel to the distance between the first two wheels. However, the difference between t₇ and t₈ (0.069 s) in FIG. 7C is not exactly the same as the difference between t₄ and t₅ (0.0575 s) in FIG. 7C, panel (d) but they are close. This can be attributed to the facts that (i) accelerometer measurements and the LDV measurements were carried out separately, and (ii) the time instant when the waves constructively interacted could not be the same for different passages of the rail car since the forces induced by the rail-wheel interaction is a random phenomenon.

### C. Missing Rail Fastener Detection

The study developed missing rail fastener detection algorithm using modal analysis.

Modal Analysis. Mode shape of the rail can describe the spatial distribution of the relative deformation across different parts of the rail (i.e., head, web, and foot) at a specific frequency. To compute mode shapes, the eigenvalue problem of the structural system using modal analysis may be solved. The resulting eigenvectors may represent the mode shapes, and the corresponding eigenvalues represent the eigenfrequencies associated with each mode. A mode that possesses large deformation in the rail head indicates that such mode is sensitive to the defect in the rail head [35] [36] [37]. Similarly, the mode that possesses large mode shape values at the rail foot indicates that such mode is sensitive to the changing of the constraints imposed by the rail fasteners.

In the study, instead of looking for one or two specific modes, a frequency bandwidth (i.e., contains a large number of modes) in which the rail foot vibrates more intensively compared to the head and the web was determined by modal analysis. The modes in this frequency range are sensitive to the change of the constraints imposed by the fasteners, which was hypothesized to serve as a good candidate for missing fasteners detection. The modal analysis was carried out for the frequency up to 10 kHz, which tend to propagate throughout the entire cross-section under 10 kHz [38].

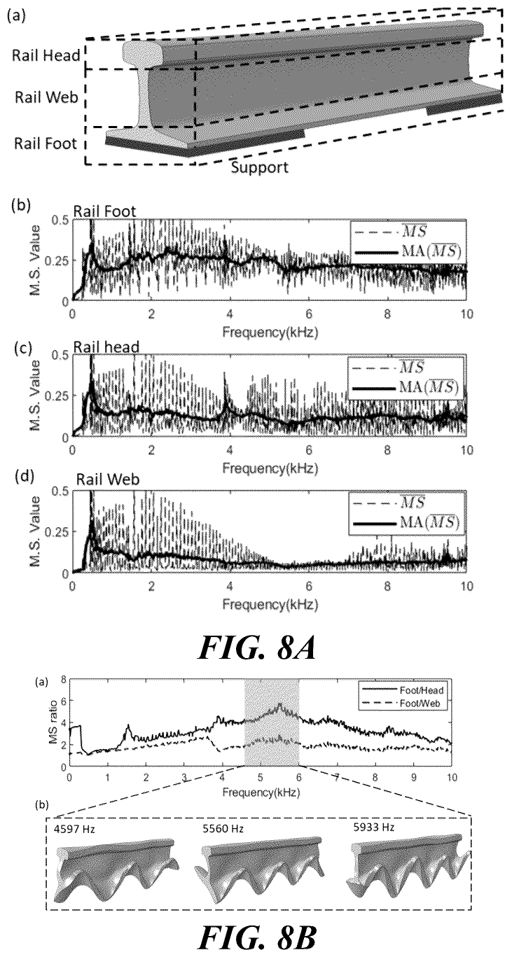

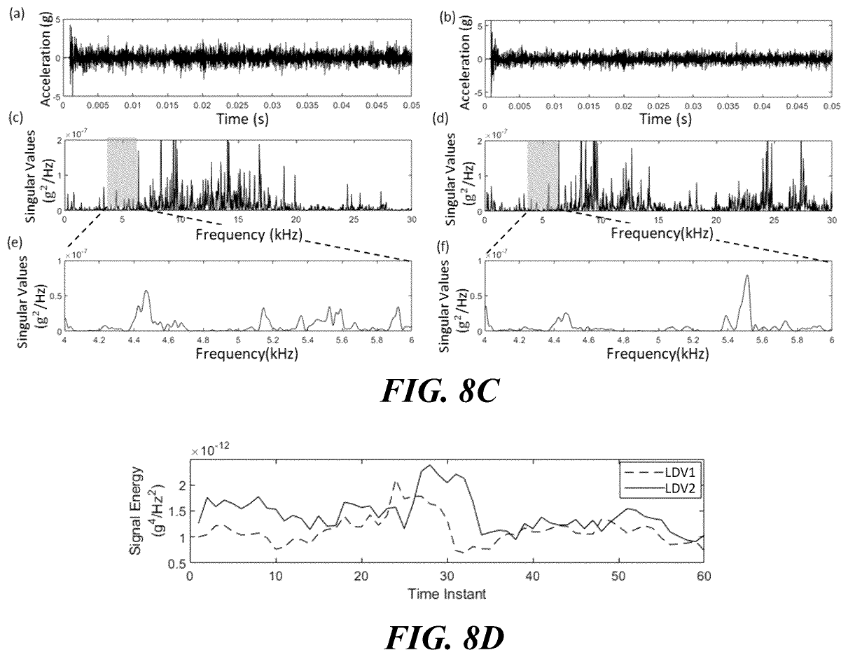

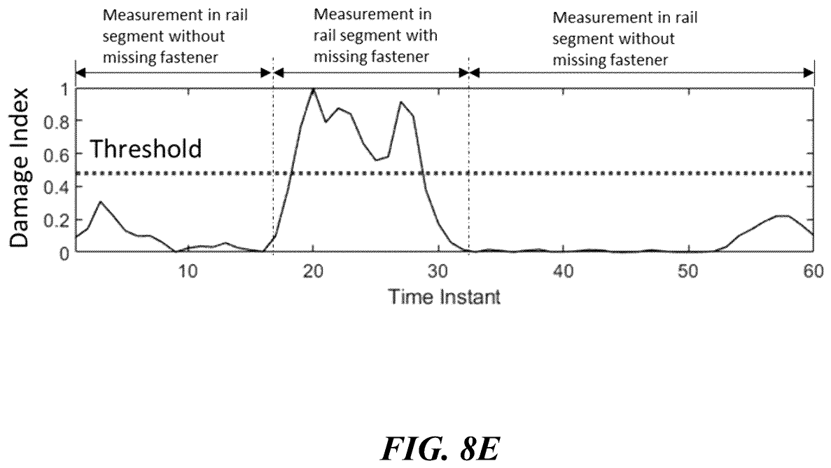

Through modal analysis, the natural frequencies and the corresponding mode shapes of one rail span in the frequency range up to 10 kHz were obtained. After obtaining the mode shapes at different natural frequencies, the mode shapes values in the vertical direction of one rail span were categorized into three groups corresponding to different parts of the rail: (i) head, (ii) web, and (iii) foot as shown in FIG. 8A, panel (a). Next, the summations of the absolute mode shape values at different frequency steps were obtained for each part of the rail, and the corresponding moving means with a window length of 20 data points were calculated and shown in FIG. 8A, panels (b)-(d).

Consequently, the ratio of the mode shape values (MS ratio) of the rail foot to the railhead were obtained by dividing the data points in FIG. 8A, panel (b) by that in FIG. 8A, panel (c). Similarly, the MS ratio of the rail foot to the rail web were obtained by dividing the data points in FIG. 8A, panel (b) by that in FIG. 8A, panel (d). The results are shown in FIG. 8B. The results demonstrated that in the frequency range of 4.5 kHz to 6 kHz, the rail has relatively large deformation at the rail foot compared to the rail web and the rail head. Some examples of the mode shapes for different modes (modes at 4597 Hz, 5560 Hz, and 5933 Hz) in this frequency range are shown in FIG. 8B, panel (b). It can be observed that, in this frequency range, the rail has large deformation in the rail foot compared to other parts of the rail. Thus, the results of the modal analysis imply that the modes in the frequency range between 4.5 kHz to 6 kHz are sensitive to the support constraints, which can be used to detect the missing fasteners. The numerical results gave a good agreement with the experimental results in terms of the sensitivity of modes to missing fasteners within the frequency range of 4 kHz to 6 kHz.

Simulated Moving Measurements. The study conducted numerical simulation that aims at replicating the moving measurements carried out in the LDV measurements. The 20-span FEM model was modified by adding infinite elements at two sides of the boundaries to prevent wave reflection. The missing rail fasteners were simulated by removing the constraints provided by one of the supports. The distance between the excitation (i.e., first wheel) to the first LDV was 2.7 meters, while the distance between the two LDVs was 0.4 m. The dimension of the fastener in the longitudinal direction of the rail was 0.2 m.

To simulate the movement of the LDV system, the continuous movement of the measurement points and the excitation was discretized into 60 time instants. The measurement points and the excitation were shifted forward in the positive z direction by 0.09 meters for every time instant. The 0.09 meters shifting was determined by considering the balance between (i) the total computational time for the simulated moving measurements and (ii) the resolution of the discrete measurements.

Missing Fastener Detection Algorithm. The study evaluated a missing fastener detection algorithm as described in relation to FIG. 4 using the data obtained from the FEM simulations. After conducting the 60 FEM simulations, a total number of sixty sets of acceleration data measured from the two measurement points were obtained. An example of time waveforms recorded by the two LDVs are shown in FIG. 8C, panel (a) and FIG. 8C, panel (b), respectively. First, for every time instant, the acceleration data obtained from the two LDVs were analyzed using FDD to obtain the SVD diagram, as shown in FIG. 8C, panel (c), and FIG. 8C, panel (d). Based on the results obtained from section 2.1 and section 3.1, the signal energy in the frequency range of 4 kHz to 6 kHz was used as the feature for the detection of the missing rail fastener. A zoom view of the SVD diagram of the two LDVs in the frequency range of 4 kHz to 6 kHz is shown in FIG. 8C, panels (e) and (f).

Second, the signal energy at the frequency range of interest (4.0 kHz to 6.0 kHz) obtained from the LDVs were calculated using Equation 9A. The smoothed signal energy is denoted as Ē_{F1}(t) and Ē_{F2}(t), as shown in FIG. 8D.

Next, at every time instant, the smoothed signal energy in the frequency range of interest obtained from the two LDVs (i.e., Ē_{F1}(t) and Ē_{F2}(t)) was divided by the smoothed total energy from 0 to 30 kHz (i.e., Ē_{T1}(t) and Ē_{T2}(t)) to obtain the Energy ratio. The energy ratio was determined using Equation 9B. Next, the normalized energy ratios R_{norm,j}(t) were obtained by normalizing the energy ratio (R₁(t) and R₂(t),) by their maximum and minimum values separately, per Equation 9C. Consequently, the damage function DF(t) is formulated by calculating the multiplication of R_{norm,1}(t) and R_{norm,2}(t) per Equation 9D. Then, a distribution is created using the points of DF(t) corresponding to the time instants in which the rail fasteners were all presented. The mean (μ) and covariance matrix (Σ) of the distribution were also obtained. Next, the Mahalanobis distance (D_{M}(t)) between each point of DF(t) and the distribution [42] can be calculated using Equation 9E. Afterward, the D_{M}(t) was normalized with respect to its maximum value to obtain the damage index (DI(t)). Then, to identify the rail segment that is affected by the missing fastener, a threshold is placed on DI(t). The threshold is considered as two standard deviations from the sample mean. Consequently, the time instant with DI(t) values exceed the threshold would be considered as the time instant when the rail damage detection system passed through the rail section affected by the missing fastener. FIG. 8E shows the damage index DI(t) obtained from the FEM simulation herein along with the threshold. It can be observed that the missing fastener detection algorithm can detect the missing fastener successfully.

### D. LSTM AE for Joint Defect Detection

In the study, an unsupervised machine learning approach was developed based on laser Doppler vibrometer measurements for joint defect detection. The vibrational data of the rail was collected through moving measurements utilizing two LDVs mounting on the rail car. The LDVs were used to collect the vertical vibrational data from the rail head. Field tests were performed at the Transportation Technology Center (TTC) in Pueblo, CO. The data was collected from moving measurements, in which the train was operating at three different speeds: 16 km/h (10 mph), 32 km/h (20 mph), and 48 km/h (30 mph). A total number of 5 data sets (one from 16 km/h, three from 32 km/h, and one from 48 km/h) were analyzed in this study. After data collection, filtering, and signal processing were applied to extract both time domain and frequency domain features from the data. Next, correlation analysis, log transformation, standardization, and Principal Component Analysis were carried out to obtain the input data used to train and validate the Long Short-Term Memory Autoencoder (LSTM AE) model. Then LSTM AE models were trained based on different data sets for anomaly detection. Consequently, an automatic anomaly detection method for broken rail based on LSTM AE was evaluated. The results show that the LSTM AE model can efficiently detect the joint based on the selected features at three different speeds.

The study developed a Long Short-Term Memory Autoencoder (LSTM AE), e.g., as described in relation to FIG. 5A, for the detection of joint defects based on laser Doppler Vibrometer (LDV) measurements. The data was collected from moving LDV measurements, in which the train was operating at three different speeds: 16 km/h (10 mph), 32 km/h (20 mph), and 48 km/h (30 mph). After obtaining the data, filtering and signal processing were applied to obtain the signal features in time and frequency domains. Next, correlation analysis and principal component analysis were carried out for feature selection and dimension reduction to determine the input used to train and test the LSTM AE model. In the study, the LSTM AE models were trained based on different data sets for anomaly detection. Consequently, an automatic anomaly detection approach for anomaly detection based on the LSTM AE model was evaluated. The results show that the LSTM AE model can efficiently detect the anomaly based on the selected features at three different speeds. LSTM AE architecture, works by encoding the input sequence into a low-dimensional representation, then reconstructing the original sequence from the encoded representation. If the input sequence is normal, the reconstructed sequence should be similar to the original.

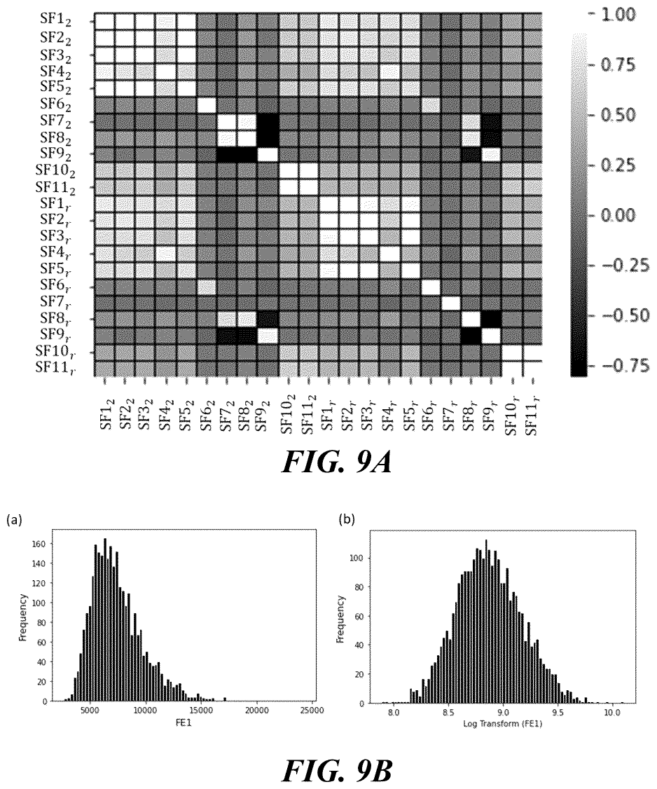

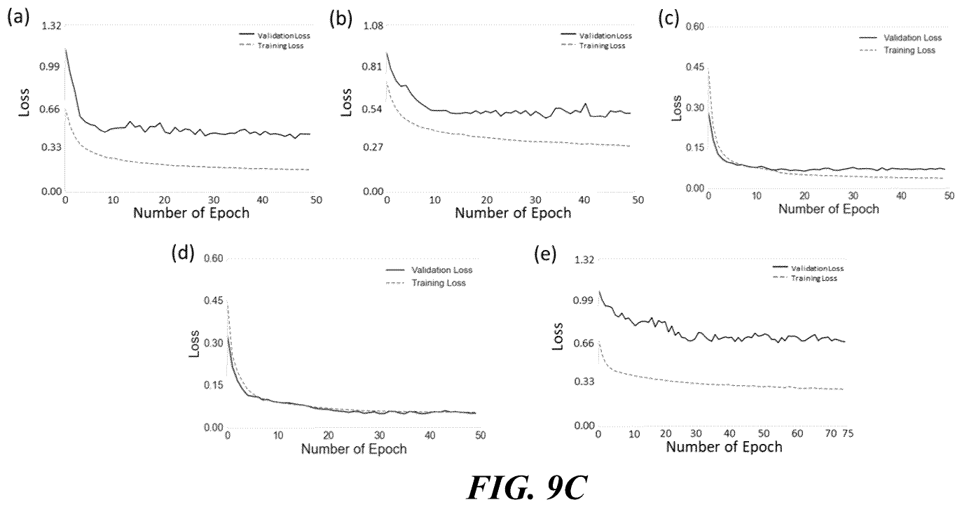

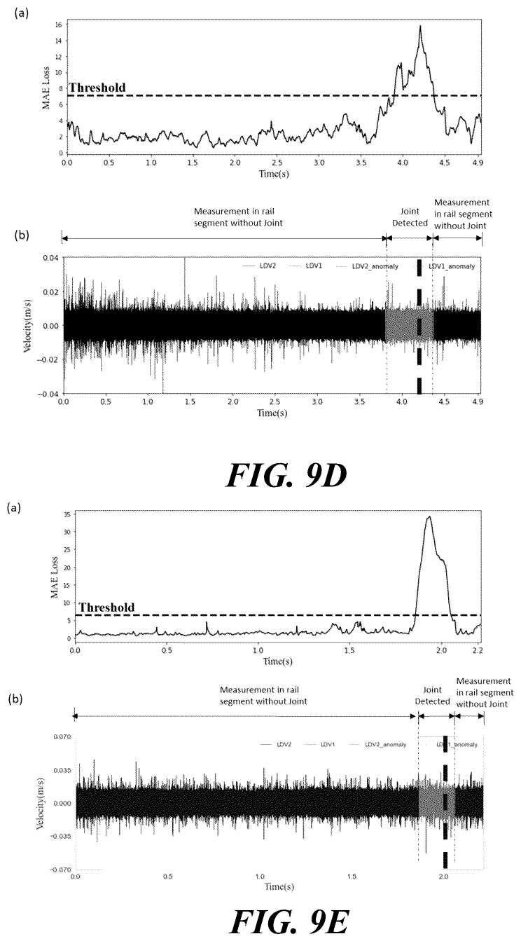

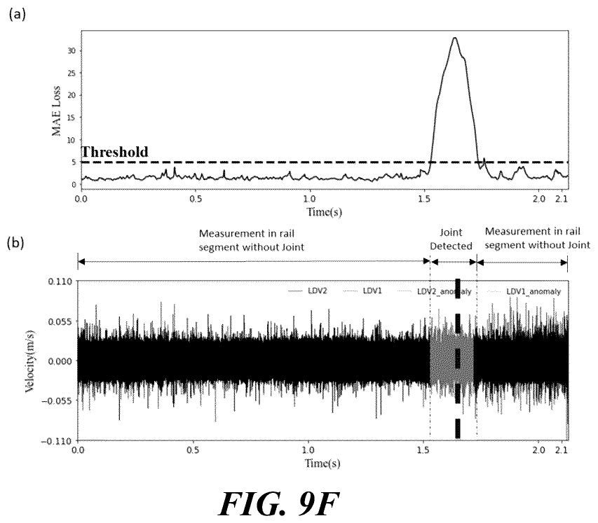

Correlation Analysis. After extracting a total number of twenty-two features from the previous section, correlation analysis was performed. FIG. 9A shows results of correlation analysis. Correlation analysis is commonly performed to identify relationships between variables in the data (i.e., input features in the neural networks). It is helpful for (i) reducing the risk of overfitting by removing features that have potential problems associated with collinearity and (ii) feature selection used for dimension reduction. The correlation analysis of the features returns Pearson's correlation coefficients between two features. The correlation coefficients measure the strength of the relationship between two variables ranging from −1 to 1. The closer the correlation coefficient is to 1 or −1, the stronger the relationship between the variables. A value of 1 indicates a perfect positive correlation, and a value of −1 indicates a perfect negative correlation.

In this study, if two features have a correlation coefficient with an absolute value higher than 0.8, the two features would be considered highly correlated, and one would be removed from the input feature. If the correlation coefficient of two features is highly positively correlated, the corresponding color is white. Similarly, if the correlation coefficient of two features is highly negatively correlated, the corresponding color is black. After conducting correlation analysis, twelve features were selected to perform the next step of data pre-processing for all the data sets: SF1₂, SF3₂ SF4₂, SF5₂, SF6₂, SF7₂ SF9₂, SF11₂, SF3ᵣ, SF5ᵣ, SF6ᵣ, SF10ᵣ as described in relation to Table 3.

Log Transformation and Standardization. Log transformation was used to transform skewed datasets into a more symmetric distribution (near-normal distribution). FIG. 9B shows an example of one of the feature's distributions (i.e., Maximum Absolute Value (SF1)) before and after applying log transformation. It can be observed that the distribution was right skewed before the log transformation, and it is close to normal distribution after the log transformation; this helps stabilize the training of the neural network. After log transformation, standardization was applied to rescale the data. Standardization was conducted by subtracting the mean of each feature from each data point and dividing it by the standard deviation of the feature. After standardization, the data was centered around the mean, and the variance was normalized so that the features had a similar scale.

Principal Component Analysis. It is known that machine learning architecture can become very complex and computationally intensive when dealing with high-dimensional data, which can slow down the training process and decrease the model's performance. The study performed Principal Component Analysis (PCA) for (i) feature extraction to transform the input feature into a lower-dimensional representation (i.e., generated features) that still retains the essential information, and (ii) feature selection to rank the features based on the amount of variance explained by the feature, for the user to prioritize them for further investigation. In the study, feature selection was applied to the data sets to identify the features that explained the most variance across different data sets. From PCA, six features were found to be most representative and explained the most variance among the others: SF3₂, SF4₂, SF6₂, SF9₂, SF10ᵣ SF11₂. These features were selected as the input for the neural networks, which allows the ML model to learn more efficiently and detect anomalies effectively.

Training and Validation. The study considered five different data sets measured under different speeds, different total time duration, and different rail dynamics, which resulted in the usage of different hyper-parameters. The model was trained and tested using the data from the same test. The data was split into training and testing sets with a proportion of 70% and 30%, respectively. In the study, the LSTM AE model was built using the Keras API with Adam optimizer. The learning rate was set to a fixed value of 0.001 and a batch size of 72. However, the total number of epochs used to train the models differed slightly. The model trained based on the data set of 16 km/h, and 32 km/h adopted 50 epochs, while the model using the data set from 48 km/h adopted 75 epochs. To assess the progress of the models' training, the training loss and validation loss versus the number of training epochs of different models were shown in FIG. 9C, which shows that the models have converged with no signs of overfitting or underfitting.

Experimental Setup. Field tests were carried out at the High Tonnage Loop (HTL) at the Transportation Technology Center. (TTC) in Pueblo, Colorado (CO). The ballasted railway track consists of 136 lb. (61.68 kg) A.R.E.A (The American Railway Engineering Association) rail, fasteners, and wood ties. The length of the rail span was approximately 0.5 m, connected to the wood ties through steel baseplates and elastic rail clips (e-clip). In this study, since (i) welded joint was commonly used to simulate the internal defects [35][36][37], and (ii) the size of internal defects is smaller than the crack of the broken rail, a welded joint was used to simulate both the reflected and transmitted waves induced by the broken rail. To identify the joint through moving measurements, the LDVs were mounted on the rail car and running pass through the rail segment with welded joint at three different speeds: 16 km/h (10 mph), 32 km/h (20 mph) and 48 km/h (30 mph). The rail vibrations induced by the wheel-rail interaction forces were recorded using the LDVs.

The two LDVs recorded the vertical vibration of the rail from the rail head. This system uses such LDV measurements to detect a change in the relative amplitudes of the recorded waves caused by a defect. Also, two different LDVs were deployed with the purpose of examining their measurement performance. The first LDV is a single-beam Polytec Vibroflex Xtra MLV-I-120, and the second LDV is a tri-beam Polytec MLV100Xtra. Both LDVs operate using infrared light technology. A better signal-to-noise ratio was expected using the MLV100Xtra since its measurements are enhanced using three laser beams. To minimize the vibration that the LDVs experience during the moving measurement, eight vibration isolators (Soitec MP28-58I) were positioned at the four corners of each LDV, connecting them to a holder frame. The lift-off distance between LDVs and the top surface of the rail head was set at 105 cm, and the distance between the laser heads was 40 cm, which were determined from a preliminary study. The controllers for the LDVs were placed inside the rail car, and a data acquisition system (Dewesoft Sirius-XHS) was utilized to record the signals. In order to reduce noise and achieve smooth signals within the desired frequency range, a sampling frequency of 1.25 MHz was selected.

Results. The results of the trained LSTM AE models for joint detection with different speeds based on LDVs measurements are presented. Five models were trained based on five data sets, resulting in the difference in hyperparameters used across the models (described in sections 2 and 3). FIG. 9D shows results of the anomaly detection of the trained LSTM AE model. The MAE loss obtained from the model and the corresponding threshold are shown in FIG. 9D, panel (a). If the MAE loss of the reconstructed data point exceeds the threshold, the data point would be considered an anomaly. The results of anomaly detection, along with the LDV data, are shown in FIG. 9D, panel (b). The time instant when the damage detection system passed the weld joint was marked as a thick black dash line, while the anomalies detected by the trained model were marked as grey lines. It is clear to see that, based on the observation of the raw LDVs data, it is not possible to identify the location of the joint in the time series. With the train LSTM AE model, the presence of joint in the time series was clearly marked. Notably, the joint's presence was identified around 3.9 seconds, with a duration of approximately 0.5 seconds.

From the result, the study concluded that (i) The LSTM AE models are able to detect the joint using data obtained from the moving LDV measurements at different speeds, and (ii) the length of the data corresponds to the detected anomalies is inversely proportional to the speed in which the data was collected. The slower the damage detection system passes through the joint, the longer the signal corresponds to the anomalies, and vice versa.

Transfer Learning. In the study, transfer learning was applied to the LSTM autoencoder for rail anomaly detection to improve the model's adaptability to varying operational speeds and different experimental setups. Transfer learning allows the model to utilize the knowledge gained from previously learned tasks by reusing, in the study, part of the encoder and decoder components of the LSTM autoencoder, which have been trained on a dataset with specific speed and setup. Transfer learning in the study then fined-tuned this pre-trained model with a smaller dataset collected from other speed or setup. This process involves partial retraining the middle layers of the model, where the weights are adjusted to the new data characteristics. It enables the model to predict anomalies under new operating conditions. This method conserves resources by avoiding the need to train a model from scratch and reduces the amount of data required for high accuracy.

In the study, transfer learning was implemented to retrain the middle five layers of the model, as shown in FIG. 5D. The first two layers in the encoder and the last three layers in the decoder were frozen. Specifically, in the encoder part, the 3^{rd}, and the 4^{th} LSTM layer, which contains 16 and 3 hidden layers were retrained using a different dataset. Also, the latent space and the decoder part (LSTM layers containing 3 and 16 hidden layers) were retrained to make the model adapt to the data capture in the different environmental parameters. Consequently, the neural network components critical for capturing characteristics related to the new speed or setup were updated. It is worth noting that transfer learning requires less data points and less effort to train the model since it is built upon prior knowledge learnt from previous data sets. Also, a lower learning rate is helpful to fine-tune the middle layers without drastically changing the characteristics captured in the previous training stage. In the initial stage of training, a learning rate of 0.01 was used while in the transfer learning stage, a learning rate of 0.001 was used to fine tune the inner layers.

Results of transfer learning. FIG. 5E shows results of the application of transfer learning for cross-dataset evaluation across various speeds within the same experimental setup. FIG. 5B shows outcomes from a model pre-trained with data at 16 km/h and enhanced through transfer learning with data collected at 48 km/h (30 mph). The evaluation of the model also utilized data from the 48 km/h speed. FIG. 5B, panel (a) shows the Mean Absolute Error obtained after applying transfer learning, alongside the established threshold. A data point is classified as an anomaly if its reconstructed MAE loss exceeds this threshold. The detection results, combined with LDV time series data, are shown in FIG. 5B, panel (b). Compared to results before transfer learning, the LSTM Autoencoder model's performance has improved significantly, now detecting anomalies accurately without false positives.

Discussion of Impulsive Noise Filter Development. Laser Doppler vibrometer (LDV) is a technology used for the non-contact measurement of surface vibrations [1]. By offering accurate measurements with a wide frequency response and a high spatial resolution, this technology has become increasingly popular in various industries, such as automotive, aerospace, biological, and railroad [2], [3]. In the context of railroads, this technology can be used to increase the spatial resolution and decrease the testing time of rail vibration measurements which are usually carried out using contact transducers [4], [5]. For instance, the authors at the University of Texas at Austin (UT Austin) have been working on a novel nondestructive evaluation (NDE) system for the inspection of railway tracks based on LDV measurements [6] taken from a moving platform. In this setting, an inherent issue of LDV measurements is the dynamic speckles in the back-reflection [7]-[9]. In particular, when a laser beam strikes a target surface while it is moving, the dynamic speckles lead to spurious jumps (impulse-like) in the signals, usually referred to as impulsive noise (IN).

The existence of IN in the rail vibration measurements taken from an LDV system mounted on a moving platform can be very problematic since some portions of the signals corresponding to different rail segments can be distorted by impulses. Consequently, the information related to some rail segments can be lost. In the context of system identification and wave propagation based approaches, such lost information and/or impulses in the signal due to IN can cause (i) poor performance of conventional system identification methods [10], [11], and (ii) misidentification of IN as damage-related vibration or wave propagation signal features [12]-[16]. Therefore, mitigating the effects of the IN plays an important role in ensuring accurate rail vibration measurements over the entire test section of a railway track.

Some studies in the literature adopted signal separation approach utilizing methods such as frequency-domain filtering, ensemble empirical mode decomposition and empirical wavelet transform to mitigate IN [17]-[20], while the others followed a two-step approach: (i) detecting the signal segments containing the IN (i.e., detection step), and (ii) replacing such segments to estimate their IN-free values (i.e., estimation step). The second approach proves more efficient for railroad applications, primarily because signal separation methods employed in the first approach are most effective when dealing with noise-free signals of interest up to approximately 2.5 kHz. However, rail frequencies up to approximately 25 kHz can be used for vibration based-SHM applications since the effect of fasteners are dominant in all vibration modes up to this frequency [4]-[6]-[21], while the frequencies after 25 kHz can be used for acoustic and ultrasonic based-NDT applications [22 [-]24]. In the context of the 2-step IN mitigation strategy, one study used a wavelet-based algorithm to detect IN observed in rail measurements performed an LDV placed on a moving platform, while adopted an autoregressive based interpolation in the estimation step [25]. However, the study also applied a low-pass filter (with a cut of frequency of 3 kHz) as a third step to minimize the residual IN.

In addition, other various signal processing techniques have been developed for the detection of IN in LDV signals, including the wavelet thresholding approach, the acceleration thresholding method, the phase-space thresholding method [26], kurtosis ratio [12], and fuzzy logic-based filter [27]. The first three methods are based on transforming the recorded signal into wavelet domain, acceleration signal, and phase-spaces (2-dimensional plots generated using the combination of the LDV signal itself and its derivatives), respectively. Afterward, signal segments containing IN are detected using thresholds. The detection step using kurtosis ratio is performed by finding the LDV signal segments with high kurtosis ratios. The detection step using a fuzzy logic filter is based on applying user-defined decision rules on the difference of consecutive signal points. For the estimation step, direct approaches such as interpolation, extrapolations, signal smoothing [26], and the weighted difference between two consecutive signal points have been used in the study [27].

However, although IN is a major concern in dynamic LDV measurements, only a limited number of studies were performed to tackle this concern. On the other hand, there are also other studies in the literature focusing on mitigating IN in other kinds of signals (e.g., biomedical, audio, speech, image, and communication signals). Most of these filters operate using detection and estimation steps as well. The filters are mainly based on linear prediction and other similar methods (e.g., Bilinear Interpolation and Adaptive Interpolation), Kalman filter and its derivatives, wavelet transformation, Bayesian statistics, Hidden Markov Model (HMM), Hilbert transform, rank-ordering, neural networks, Hampel filter, template matching, and Nonnegative Matrix Factorization (NMF).

Linear prediction based methods perform the detection step by considering the difference between the estimated and recorded signal points [28], [29]. The estimation step is performed using the estimated signal points in the segments containing IN, which are computed using iterative algorithms resembling Expectation-Maximization [29]-[31] or forward and backward linear prediction [32]. The methods employing the Kalman filter and its derivatives also function similarly, but use more information from the recorded signal [33]-[35]. The detection step using Wavelet transformation is implemented using thresholds after transforming the signals into wavelet domain [36]-[38]. The estimation step is performed by transforming the signals back to the time domain after segments containing IN are manipulated in the wavelet domain. Bayesian statistics-based methods implement Bayesian approach to the noise and signal distributions [39]-[42]. Such methods carry out the detection and estimation steps through the maximization of the conditional probabilities of IN locations, and the recorded and estimated signals. A similar approach is used in a method based on HMM [13]. This method detects IN based on the probability of a signal point belonging to IN and IN-free segments by using HMM and appropriate distributions of the segments containing IN and IN-free segments. The method estimates IN-free values using the random variables of the IN-free segments' probability distribution. Hilbert transform based method performs the detection step by creating a signal envelope (threshold), while it performs the estimation step by using the values of the envelope at the IN corrupted segments [43]. In the methods based on rank-ordered, for the detection step, (i) the middle value or the average of two middle values in signal windows (which are rank-ordered), or (ii) the differences of these middle values with other signal points in the windows are used [44]-[49]. These middle values are directly used in the estimation step, or they are embedded in a signal smoothing filter [28], [44], [45], [47], [49]-[53]. Neural networks perform detection and estimation after they are trained with many signals [54]-[57]. However, the rank-ordered based methods (e.g., Median filter) and neural networks were more generally used for two-dimensional image signals. The detection step of Hampel Filter is based on creating thresholds based on outlier-robust statistics such as median and median absolute deviation, and the estimation step is based on replacing the detected IN-corrupted signal points with the median [58].

However, some methods can be used only for the detection step. For example, template matching is used to detect IN using the templates of IN's patterns [59]. One type of Neural Network (i.e., self-organizing map) is also used only for the detection step [60]. The NMF based method detects IN by extracting the signal components that contain only IN [16]. This is performed by encoding the measured signal into different components and then grouping them into different classes using a classification algorithm.

There are also missing signal estimation algorithms which can be applied to replace the signal segments containing IN. Such algorithms are based on fitting parametric models to estimate the missing signal points using different methods such as (i) Kalman filters and expectation-maximization (EM) algorithms [61-63], (ii) the EM with data augmentation, (iii) the EM with multiple imputations, (iv) the Markov Chain Monte Carlo (i.e., MCMC) with multiple imputations, and (v) the regression method with multiple imputations [64], [65].

In this study, the IN filter was developed to mitigate the effects of the IN in rail vibration signals collected by an LDV placed on an operating train for a wide range of different applications (e.g., system identification, wave propagation-based damage detection) without limiting the frequency of the noise free signal of interest. Accordingly, the filter was designed to exhibit a robust IN detection performance and replace the segments containing IN as close as to their IN-free values. Overall, this filter consists of two main steps (detection and estimation), each involving two different methods. The performance of this filter was evaluated on a synthetic signal which was created through field and laboratory tests. Specifically, field tests were carried out to obtain the rail vibration component of the signal induced by wheel/rail contact (i.e., vibration component), while an experimental set-up was designed in the Ferguson Structural Engineering Laboratory (FSEL) at UT Austin to simulate the speckle noise component of the signal (i.e., noise component). The advantage of using a synthetic signal were (i) to validate the performance of the proposed IN filter through qualitative and quantitative assessments as well as (ii) to examine the speckle noise's behavior separately. A visual inspection of the noise component showed that IN manifests itself as artificial peaks, and also as fluctuations caused by the local increase in the frequency of speckle noise (i.e., artificial fluctuations). Accordingly, the IN filter was designed to detect and replace both artificial peaks and fluctuations.

### CONCLUSION

In one configuration, the circuits of the control system are in the form of machine or computer-readable media that is executable by a processor, such as processor. As described herein, the machine-readable media facilitates performance of certain operations to enable reception and transmission of data. For example, the machine-readable media may provide an instruction (e.g., command, etc.) to acquire data. In this regard, the machine-readable media may include programmable logic that defines the frequency of acquisition of the data (or, transmission of the data). The computer readable media may include code written in any programming language. The computer readable program code may be executed on one processor, multiple co located processors, multiple remote processors, or any combination of local and remote processors. Remote processors may be connected to each other through any type of network (e.g., CAN bus, etc.).

In another configuration, the circuits of the control system are implemented as hardware units, such as electronic control units. As such, the circuits of the control system may be implemented as one or more circuitry components including, but not limited to, processing circuitry, network interfaces, peripheral devices, input devices, output devices, sensors, etc. In some implementations, the circuits of the control system may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the circuits of the control system may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The circuits of the control system may also include programmable hardware devices such as field programmable gate arrays, programmable array logic, programmable logic devices or the like. The circuits of the control system may include one or more memory devices for storing instructions that are executable by the processor(s) of the circuits of the control system. The one or more memory devices and processor(s) may have the same definition as provided below with respect to the memory device and processor. In some hardware unit configurations, the circuits of the control system may be geographically dispersed throughout separate locations. Alternatively and as shown, the circuits of the control system may be implemented in or within a single unit/housing, which is shown as the controller.

In the example shown, the controller includes the processing circuit having the processor and the memory device. The processing circuit may be structured or configured to execute or implement the instructions, commands, and/or control processes described herein with respect to the circuits of the control system. The depicted configuration represents the circuits of the control system as machine or computer-readable media. However, as mentioned above, this illustration is not meant to be limiting as the present disclosure contemplates other implementations where the circuits of the control system, or at least one circuit of the circuits of the control system, is configured as a hardware unit. All such combinations and variations are intended to fall within the scope of the present disclosure.

The hardware and data processing components used to implement the various processes, operations, illustrative logics, logical blocks, modules and circuits described in connection with the implementations disclosed herein (e.g., the processor) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some implementations, the one or more processors may be shared by multiple circuits (e.g., the circuits of the control system may comprise or otherwise share the same processor which, in some example implementations, may execute instructions stored, or otherwise accessed, via different areas of memory). Alternatively or additionally, the one or more processors may be structured to perform or otherwise execute certain operations independent of one or more co-processors. In other example implementations, two or more processors may be coupled via a bus to enable independent, parallel, pipelined, or multi-threaded instruction execution. All such variations are intended to fall within the scope of the present disclosure.

The memory device (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device may be communicably connected to the processor to provide computer code or instructions to the processor for executing at least some of the processes described herein. Moreover, the memory device may be or include tangible, non-transient volatile memory or non-volatile memory. Accordingly, the memory device may include database components, object code components, script components, or any other type of information structure for supporting the various activities and information structures described herein.

It should be understood that the controller may include any number of circuits for completing the functions described herein. For example, the activities and functionalities of the circuits of the control system may be combined in multiple circuits or as a single circuit. Additional circuits with additional functionality may also be included. Further, the controller may further control other activity beyond the scope of the present disclosure. In some implementations, the circuits described herein may include one or more processing circuits comprising one or more memory devices coupled to one or more processors, the one or more memory devices configured to store instructions thereon that, when executed by the one or more processors, cause the one or more processors to perform the operations performed herein and described with reference to circuits.

As mentioned above and in one configuration, the “circuits” may be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be implemented in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some implementations, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

The following patents, applications, and publications, as listed below and throughout this document, are hereby incorporated by reference in their entirety herein.
[1] D. Di Maio, P. Castellini, M. Martarelli, S. Rothberg, M. S. Allen, W. D. Zhu, D. J. Ewins, Continuous Scanning Laser Vibrometry: A raison d'être and applications to vibration measurements, Mech Syst Signal Process 156 (2021) 107573. https://doi.org/10.1016/j.ymssp.2020.107573.
[2] P. Castellini, M. Martarelli, E. P. Tomasini, Laser Doppler Vibrometry: Development of advanced solutions answering to technology's needs, Mech Syst Signal Process 20 (2006) 1265-1285. https://doi.org/10.1016/j.ymssp.2005.11.015.
[3] D. Di Maio, P. Castellini, M. Martarelli, S. Rothberg, M. S. Allen, W. D. Zhu, D. J. Ewins, Continuous Scanning Laser Vibrometry: A raison d'être and applications to vibration measurements, Mech Syst Signal Process 156 (2021). https://doi.org/10.1016/j.ymssp.2020.107573.
[4] K. Kaynardag, G. Battaglia, C. Yang, S. Salamone, Experimental Investigation of the Modal Response of a Rail Span during and after Wheel Passage, Transp Res Rec (2020). https://doi.org/https://doi.org/10.1177/0361198120966931.
[5] J. Ryue, D. J. Thompson, P. R. White, D. R. Thompson, Investigations of propagating wave types in railway tracks at high frequencies, J Sound Vib 315 (2008) 157-175. https://doi.org/10.1016/j.jsv.2008.01.054.
[6] K. Kaynardag, G. Battaglia, A. Ebrahimkhanlou, A. Pirrotta, S. Salamone, Identification of Bending Modes of Vibration in Rails by a Laser Doppler Vibrometer on a Moving Platform, Exp Tech 45 (2020) 13-24. https://doi.org/10.1007/s40799-020-00401-9.
[7] S. J. Rothberg, B. J. Halkon, Laser vibrometry meets laser speckle, Sixth International Conference on Vibration Measurements by Laser Techniques: Advances and Applications 5503 (2004) 280. https://doi.org/10.1117/12.579760.
[8] A. Dräbenstedt, Quantification of displacement and velocity noise in vibrometer measurements on transversely moving or rotating surfaces, in: Optical Measurement Systems for Industrial Inspection V, 2007: p. 661632. https://doi.org/10.1117/12.726115.
[9] Y. Jin, R. Dollevoet, Z. Li, Numerical simulation and characterization of speckle noise for laser Doppler vibrometer on moving platforms (LDVom), Opt Lasers Eng 158 (2022). https://doi.org/10.1016/j.optlaseng.2022.107135.
[10] B. Weng, K. E. Barner, Nonlinear system identification in impulsive environments, IEEE Transactions on Signal Processing 53 (2005) 2588-2594. https://doi.org/10.1109/TSP.2005.849213.
[11] S. Jing, Identification of the ARX Model with Random Impulse Noise Based on Forgetting Factor Multi-error Information Entropy, Circuits Syst Signal Process 41 (2022) 915-932. https://doi.org/10.1007/s00034-021-01809-3.
[12] J. Vass, R. Šmíd, R. B. Randall, P. Sovka, C. Cristalli, B. Torcianti, Avoidance of speckle noise in laser vibrometry by the use of kurtosis ratio: Application to mechanical fault diagnostics, Mech Syst Signal Process 22 (2008) 647-671. https://doi.org/10.1016/j.ymssp.2007.08.008.
[13] A. Wylomanska, R. Zimroz J. Janczura, J. Obuchowski, Impulsive Noise Cancellation Method for Copper Ore Crusher Vibration Signals Enhancement, IEEE Transactions on Industrial Electronics 63 (2016) 5612-5621. https://doi.org/10.1109/TIE.2016.2564342.
[14] J. Hebda-Sobkowicz, R. Zimroz M. Pitera, A. Wyłomańska, Informative frequency band selection in the presence of non-Gaussian noise—a novel approach based on the conditional variance statistic with application to bearing fault diagnosis, Mech Syst Signal Process 145 (2020). https://doi.org/10.1016/j.ymssp.2020.106971.
[15] F. L. Di Scalea, X. Zhu, M. Capriotti, A. Y. Liang, S. Mariani, S. Sternini, Passive extraction of dynamic transfer function from arbitrary ambient excitations: Application to high-speed rail inspection from wheel-generated waves, J Nondestruct Eval Diagn Progn Eng Syst 1 (2018). https://doi.org/10.1115/1.4037517.
[16] J. Wodecki, A. Michalak, R. Zimroz Local damage detection based on vibration data analysis in the presence of Gaussian and heavy-tailed impulsive noise, Measurement (Lond) 169 (2021) 108400. https://doi.org/10.1016/j.measurement.2020.108400.
[17] Y. Jin, Z. Li, Mitigating speckle noise in a laser Doppler vibrometer using Fourier analysis, Opt Lett 47 (2022) 4742. https://doi.org/10.1364/ol.456040.
[18] Y. Jin, R. Dollevoet, Z. Li, Removing speckle noise from the signals of a laser Doppler vibrometer on moving platforms (LDVom) by ensemble empirical mode decomposition, Meas Sci Technol 33 (2022). https://doi.org/10.1088/1361-6501/ac8daf.
[19] Y. Jin, Z. Li, A new method for eliminating speckle noise from Laser Doppler Vibrometer signals, in: J Phys Conf Ser, IOP Publishing Ltd, 2021. https://doi.org/10.1088/1742-6596/2041/1/012007.
[20] Y. Jin, Z. Li, Eliminating Speckle Noises for Laser Doppler Vibrometer Based on Empirical Wavelet Transform, in: Proceedings of the 13th International Conference on Measurement, MEASUREMENT 2021, Institute of Electrical and Electronics Engineers Inc., 2021: pp. 72-75. https://doi.org/10.23919/Measurement52780.2021.9446777.
[21] C. Yang, K. Kaynardag, S. Salamone, Missing Rail Fastener Detection Based on Laser Doppler Vibrometer Measurements, J Nondestr Eval 42 (2023). https://doi.org/10.1007/s10921-023-00981-7.
[22] K. Kaynardag, C. Yang, S. Salamone, The Numerical Simulations to Examine The Interaction Of Train-Induced Guided Waves With Transverse Cracks, Transp Res Rec (2022). https://doi.org/10.1177/036119812210945.
[23] F. L. Di Scalea, X. Zhu, M. Capriotti, A. Y. Liang, S. Mariani, S. Sternini, Passive extraction of dynamic transfer function from arbitrary ambient excitations: Application to high-speed rail inspection from wheel-generated waves, J Nondestruct Eval Diagn Progn Eng Syst 1 (2018). https://doi.org/10.1115/1.4037517.
[24] S. Coccia, I. Bartoli, A. Marzani, F. Lanza Di Scalea, S. Salamone, M. Fateh, Numerical and experimental study of guided waves for detection of defects in the rail head, NDT and E International 44 (2011) 93-100. https://doi.org/10.1016/j.ndteint.2010.09.011.
[25] Y. Zeng, A. Núñez, Z. Li, Speckle noise reduction for structural vibration measurement with laser Doppler vibrometer on moving platform, Mech Syst Signal Process 178 (2022). https://doi.org/10.1016/j.ymssp.2022.109196.
[26] D. G. Goring, V. I. Nikora, Despiking acoustic doppler velocimeter data, Journal of Hydraulic Engineering 128 (2002) 117-126. https://doi.org/10.1061/(ASCE)0733-9429(2002)128:1(117).
[27] D. Naso, A. Scalera, G. Aurisicchio, B. Turchiano, Removing spike noise from railway geometry measures with a fuzzy filter, IEEE Transactions on Systems, Man and Cybernetics Part C: Applications and Reviews 36 (2006) 485-494. https://doi.org/10.1109/TSMCC.2006.875422.
[28] A. Roy, R. H. Laskar, Non-casual linear prediction based adaptive filter for removal of high density impulse noise from color images, AEU—International Journal of Electronics and Communications 72 (2017) 114-124. https://doi.org/10.1016/j.aeue.2016.12.006.
[29] L. Oudre, Automatic Detection and Removal of Impulsive Noise in Audio Signals, Image Processing On Line 5 (2015) 267-281. https://doi.org/10.5201/ipol.2015.64.
[30] S. Figure, Detection and suppression of impulsive noise in speech communication systems, IEE Proceedings I—Communications, Speech and Vision 137 (1990) 38-46. https://doi.org/10.1049/ip-i-2.1990.0007.
[31] A. J. E. M. Janseen, R. Veldhuis, L. Vries, Adaptive interpolation of discrete-time signals that can be modeled as autoregressive processes, IEEE Trans Acoust 34 (1986) 317-330. https://doi.org/10.1109/TASSP.1986.1164824.
[32] M. Niedźwiecki, M. Ciołek, Elimination of impulsive disturbances from archive audio signals using bidirectional processing, IEEE Trans Audio Speech Lang Process 21 (2013) 1046-1059. https://doi.org/10.1109/TASL.2013.2244090.
[33] G. Doblinger, Adaptive Kalman smoothing of AR signals disturbed by impulses and colored noise, 1998 IEEE Symposium on Advances in Digital Filtering and Signal Processing, DFSP 1998 (1998) 72-76. https://doi.org/10.1109/ADFSP.1998.685698.
[34] M. Niedźwiecki, C. Krzysztof, Adaptive scheme for elimination of broadband noise and impulsive disturbances from AR and ARMA signals, IEEE Transactions on Signal Processing 44 (1996) 528-537. https://doi.org/10.1109/78.489026.
[35] S. Canazza, G. De Poli, G. A. Mian, Restoration of audio documents by means of extended Kalman filter, IEEE Trans Audio Speech Lang Process 18 (2010) 1107-1115. https://doi.org/10.1109/TASL.2009.2030005.
[36] J. C. Valiere, S. Montresor, J. F. Allard, M. Baudry, The restoration of Old Recordings by means of Digital Techniques, in: Audio Engineering Society Convention 88, Montreux, Switzerland, 1990.
[37] R. C. Nongpiur, Impulse Noise Removal in Speech Using Wavelets, in: 2008 IEEE International Conference on Acoustics, Speech and Signal Processing, 2008: pp. 1593-1596. https://doi.org/10.1109/ICASSP.2008.4517929.
[38] R. C. Nongpiur, D. J. Shpak, Impulse-noise suppression in speech using the stationary wavelet transform, J Acoust Soc Am 133 (2013) 866-879. https://doi.org/10.1121/1.4773264.
[39] L. Pasteur, R. Koch, Statistical Reconstruction and Analysis of Autoregressive Signals in Impulsive Noise, IEEE Transactions on Speech and Audio Processing 6 (1998) 352-372. https://doi.org/10.1109/89.701365.
[40] S. J. Godsill, P. J. W. Rayner, A Bayesian Approach to the Restoration of Degraded Audio Signals, IEEE Transactions on Speech and Audio Processing 3 (1995) 267-278. https://doi.org/10.1109/89.397091.
[41] F. R. Ávila, L. W. P. Biscainho, Bayesian restoration of audio signals degraded by impulsive noise modeled as individual pulses, IEEE Trans Audio Speech Lang Process 20 (2012) 2470-2481. https://doi.org/10.1109/TASL.2012.2203811.
[42] H. Wan, X. Ma, X. Li, Variational Bayesian learning for removal of sparse impulsive noise from speech signals, Digital Signal Processing: A Review Journal 73 (2018) 106-116. https://doi.org/10.1016/j.dsp.2017.11.007.
[43] U. Melia, F. Clariá, M. Vallverdú, P. Caminal, Filtering and thresholding the analytic signal envelope in order to improve peak and spike noise reduction in EEG signals, Med Eng Phys 36 (2014) 547-553. https://doi.org/10.1016/j.medengphy.2013.11.014.
[44] E. Abreu, S. K. Mztra, A signal-dependent rank ordered mean (SD-ROM) filter—a new approach for removal of impulses from highly corrupted images, International Conference on Acoustics, Speech, and Signal Processing (1995) 2371-2374. https://doi.org/10.1109/ICASSP.1995.479969.
[45] R. Garnett, T. Huegerich, C. Chui, W. He, An Universal Noise Removal Algorithm With an Impulse Detector, IEEE Transactions on Image Processong 14 (2005) 1747-1754. https://doi.org/10.1109/TIP.2005.857261.
[46] Y. Dong, R. H. Chan, S. Xu, A detection statistic for random-valued impulse noise, IEEE Transactions on Image Processing 16 (2007) 1112-1120. https://doi.org/10.1109/TIP.2006.891348.
[47] P. Ng, K.-K. Ma, A Switching Median Filter With Boundary Discriminative Noise Detection for Extremely Corrupted Images, IEEE Transactions on Image Processing 15 (2006) 1506-1516.
[48] F. Duan, Y. J. Zhang, A highly effective impulse noise detection algorithm for switching median filters, IEEE Signal Process Lett 17 (2010) 647-650. https://doi.org/10.1109/LSP.2010.2049515.
[49] I. F. Jafar, R. A. Alna'Mneh, K. A. Darabkh, Efficient improvements on the BDND filtering algorithm for the removal of high-density impulse noise, IEEE Transactions on Image Processing 22 (2013) 1223-1232. https://doi.org/10.1109/TIP.2012.2228496.
[50] V. R. Vijaykumar, D. Ebenezer, P. T. Vanathi, Detail Preserving Median Based Filter for Impulsive Noise Removal in Digital Images, in: 9th International Conference on Signal Processing, 2008: pp. 793-796.
[51] Y. Dong, S. Xu, A new directional weighted median filter for removal of random-valued impulse noise, IEEE Signal Process Lett 14 (2007) 193-196. https://doi.org/10.1109/LSP.2006.884014.
[52] S. Khan, D. H. Lee, An adaptive dynamically weighted median filter for impulse noise removal, EURASIP J Adv Signal Process 2017 (2017). https://doi.org/10.1186/s13634-017-0502-z.
[53] I. A. Shaik, K. J. S. Lorraine, Impulse Noise Detection and Filtering Based On Adaptive Weighted Median Filter, International Journal of Engineering and Science 1 (2012) 49-54.
[54] A. Rezvanian, K. Faez, F. Mahmoudi, A two-pass method to impulse noise reduction from digital images based on neural networks, Proceedings of ICECE 2008—5th International Conference on Electrical and Computer Engineering 00 (2008) 400-405. https://doi.org/10.1109/ICECE.2008.4769240.
[55] C. Budak, M. Türk, A. Toprak, Reduction in impulse noise in digital images through a new adaptive artificial neural network model, Neural Comput Appl 26 (2015) 835-843. https://doi.org/10.1007/s00521-014-1767-x.
[56] H. Y. Khaw, F. C. Soon, J. H. Chuah, C. O. Chow, High-density impulse noise detection and removal using deep convolutional neural network with particle swarm optimisation, IET Image Process 13 (2019) 365-374. https://doi.org/10.1049/iet-ipr.2018.5776.
[57] G. Li, X. Xu, M. Zhang, Q. Liu, Densely connected network for impulse noise removal, Pattern Analysis and Applications 23 (2020) 1263-1275. https://doi.org/10.1007/s10044-020-00871-y.
[58] R. K. Pearson, Y. Neuvo, J. Astola, M. Gabbouj, Generalized Hampel Filters, EURASIP J Adv Signal Process 2016 (2016). https://doi.org/10.1186/s13634-016-0383-6.
[59] M. Niedźwiecki, M. Ciołek, Localization of impulsive disturbances in audio signals using template matching, Digital Signal Processing: A Review Journal 46 (2015) 253-265. https://doi.org/10.1016/j.dsp.2015.07.009.
[60] H. Kong, L. Guan, A neural network adaptive filter for the removal of impulse noise in digital images, Neural Networks 9 (1996) 373-378. https://doi.org/10.1016/0893-6080 (95) 00128-X.
[61] R. Zgheib, G. Fleury, E. Lahalle, New fast algorithm for simultaneous identification and optimal reconstruction of non stationary AR processes with missing observations, 2006 IEEE 12th Digital Signal Processing Workshop and 4th IEEE Signal Processing Education Workshop (2006) 371-376. https://doi.org/10.1109/DSPWS.2006.265414.
[62] T. J. Matarazzo, S. N. Pakzad, Structural identification for mobile sensing with missing observations, J Eng Mech 142 (2016) 1-18. https://doi.org/10.1061/(ASCE)EM.1943-7889.0001046.
[63] M. Horner, S. N. Pakzad, N. S. Gulgec, Parameter Estimation of Autoregressive-Exogenous and Autoregressive Models Subject to Missing Data Using Expectation Maximization, Front Built Environ 5 (2019) 1-18. https://doi.org/10.3389/fbuil.2019.00109.
[64] S. A. Imtiaz, S. L. Shah, Treatment of missing values in process data analysis, Canadian Journal of Chemical Engineering 86 (2008) 838-858. https://doi.org/10.1002/cjce.20099.
[65] Y. Dong, C. Y. J. Peng, Principled missing data methods for researchers, Springerplus 2 (2013) 1-17. https://doi.org/10.1186/2193-1801-2-222.
[66] S. W. Smith, The Scientist and Engineer's Guide to Digital Signal Processing Second Edition, California Technical Publishing, San Diego, 1999.
[67] S. V. Vaseghi, Advanced Digital Signal Processing and Noise Reduction, Fourth Edition, John Wiley and Sons, 2008.
[68] M. Jansen, Noise Reduction by Wavelet Tresholding, Springer-Verlag, New York, 2001.
[69] P. J. Rousseeuw, C. Croux, Alternatives to the median absolute deviation, J Am Stat Assoc 88 (1993) 1273-1283. https://doi.org/10.1080/01621459.1993.10476408.
[70] A. Abbate, J. Koay, J. Frankel, S. C. Schroeder, P. Das, Signal detection and noise suppression using a wavelet transform signal processor: application to ultrasonic flaw detection, IEEE Trans Ultrason Ferroelectr Freq Control 44 (1997) 14-26. https://doi.org/10.1109/58.585186.
[71] K. Wirsing, Time Frequency Analysis of Wavelet and Fourier Transform, Intech 32 (2013) 137-144.
[72] S. Salvador, P. Chan, Determining the Number of Clusters/Segments in Hierarchical Clustering/Segmentation Algorithms, in: 16th IEEE International Conference on Tools with Artificial Intelligence, 2004: pp. 576-584.
[73] L. Lapidus, J. H. Seinfeld, Numerical solution of ordinary differential equations, Academic Press Inc., New York, 1971.
[74] M. Niedźwiecki, Statistical Reconstruction of Multivariate Time Series, IEEE Transactions on Signal Processing 41 (1993) 451. https://doi.org/10.1109/TSP.1993.193177.
[75] S. M. Alessio, Digital Signal Processing and Spectral Analysis for Scientists, Springer International Publishing, Switzerland, 2016.
[76] P. G. Georgiou, Alpha-stable modeling of noise and robust timedelay estimation in the presence of impulsive noise, IEEE 1 (1999) 291-301. Trans Multimedia https://doi.org/10.1109/6046.784467.
[77] James Douglas Hamilton, Time Series Analysis, Princeton, Princeton, 2020.
[78] J. H. McCulloch, Simple consistent estimators of stable distribution parameters, Commun Stat Simul Comput 15 (1986) 1109-1136. https://doi.org/10.1080/03610918608812563.
[79] E. F. Fama, R. Roll, Parameter estimates for symmetric stable distributions, J Am Stat Assoc 66 (1971) 331-338. https://doi.org/10.1080/01621459.1971.10482264.
[80] G. A. Tsihrintzis, C. L. Nikias, Fast estimation of the parameters of alpha-stable impulsive interference, IEEE Transactions on Signal Processing 44 (1996) 1492-1503. https://doi.org/10.1109/78.506614.
[81] P. W. Loveday, C. S. Long, and D. A. Ramatlo, “Ultrasonic guided wave monitoring of an operational rail track,” 2020, doi: 10.1177/1475921719893887.
[82] R. Brincker, L. Zhang, and P. Andersen, “Modal identification of output-only systems using frequency domain decomposition,” Smart Mater Struct, vol. 10, no. 3, pp. 441-445, 2001, doi: 10.1088/0964-1726/10/3/303.

What is claimed is:

1. A system for detecting internal defects in a railway track, the system comprising:
a laser Doppler vibrometer sensor assembly mounted to a mobile defect detection platform having one or more excitation mechanisms configured to cause impact forces on a railway track and generate transverse waves therein while the mobile defect detection platform is moving, the laser Doppler vibrometer sensor assembly being configured to sense and measure, at one or more locations relative to the excitation mechanism, while the mobile defect detection platform is moving, vibration measurements representing the transverse waves from vibrations of the railway track caused by the impact forces of the excitation mechanism, the laser doppler vibrometer sensor assembly comprising one or more laser Doppler vibrometer sensors and a coupling member configured to mount the one or more laser doppler vibrometer sensors to a portion of the mobile defect detection platform;
wherein the vibration measurements are processed by one or more filters to (i) remove speckle noise caused by movement of the laser Doppler vibrometer sensor assembly along the railway track and (ii) correct distorted portions of the vibration measurements cause by impulses from train wheels of the mobile defect detection platform to generate a filtered vibration measurement, and wherein the filtered vibration measurements are analyzed to determine one or more defects in the railway track for maintenance, repair, or visualization of conditions of the railway track.

2. The system of claim 1, wherein the one or more filters comprises an impulsive noise filter configured to (i) detect an artificial peak and a fluctuation in a signal segment of the vibration measurements and (ii) smooth and interpolate the signal segment to generate the filtered vibration measurement.

3. The system of claim 1, further comprising:
an analysis system comprising a processor and a memory having instructions stored thereon, wherein execution of the instructions by the processor causes the processor to:
receive vibration data corresponding to the vibration measurements measured by the laser Doppler vibrometer sensor assembly;
detect, via an impulsive noise filter, a signal segment of the vibration data containing an impulsive noise artifact;
replace or modify, via the impulsive noise filter, the detected signal segment with a corrected segment with the impulsive noise artifact removed or lessened to generate a filtered vibration data; and
determine, the defect in the railway track using the filtered vibration data,
wherein the determined defect in the railway track is outputted in a report for maintenance, repair, or visualization of defects of the railway track.

4. The system of claim 1, wherein the laser doppler vibrometer sensor assembly comprises a first laser doppler vibrometer and a second laser doppler vibrometer, as the one or more laser doppler vibrometer sensors, wherein each of the first laser doppler vibrometer and the second laser doppler vibrometer is configured to capture vibration data representing vibrations of the railway track caused by the impact force of the excitation mechanism at a first location relative to the excitation mechanism and a second location relative to the excitation mechanism, respectively,
wherein vibration data from the first laser Doppler vibrometer and the second laser Doppler vibrometer are compared or combined to one another to extract or determine signal features that informs the defect detection.

5. The system of claim 2, wherein the one or more filters include a signal smoothing operator configured to smooth the signal segment containing the artificial fluctuation, the smoothed signal segment having reduced higher frequency signal components.

6. The system of claim 2, wherein the one or more filters include an interpolation operator configured to interpolate the signal segment containing the artificial peak, the interpolation operator comprising an autoregressive model to interpolate the signal segment at the artificial peak.

7. The system of claim 3, wherein the processor is further configured to:
apply a transfer function to adjust for differences in the speed of vibration data collection.

8. The system of claim 2, wherein the one or more filters comprise a Phase Space Thresholding operator, a Stationary Wavelet Package Transformation Thresholding operator, an artificial peak and/or fluctuation operator, a moving average filter with Gaussian weights and Bilinear Interpolation, or a combination thereof.

9. The system of claim 3, wherein the analysis system further comprises:
an anomaly detector comprising a trained AI model configured to detect broken rails in the railway track based on the filtered vibration data, wherein the detected broken rails are outputted in the report for maintenance, repair, or visualization of defects of the railway track.

10. The system of claim 3, wherein the analysis system further comprises:
a missing rail fastener detector configured to perform modal analysis using the filtered vibration data.

11. The system of claim 9, wherein the trained machine learning model was trained using vibration data from one or more mobile defect detections platforms having varied speeds along the railway track, varied defect types, or varied environmental conditions.

12. The system of claim 1, wherein the defect in the railway track is surface defect on a surface of the railway track or a missing fastener adjacent to the railway track.

13. The system of claim 1, wherein the laser Doppler vibrometer sensor assembly is mounted to a rail car as the mobile defect detection platform, the rail car being movable along the railway track and comprising a frame as the coupling member extending therefrom.

14. The system of claim 3, wherein the laser Doppler vibrometer sensor assembly is operatively coupled to a global positioning system, the controller being configured annotate the one or more defects in the railway track with global positioning coordinate from the global positioning system.

15. A analysis system for detecting defects in a railway track, the analysis system comprising a processor and a memory having instructions stored thereon, wherein execution of the instructions by the processor causes the processor to:
receive vibration data corresponding to vibration measurements measured by a laser Doppler vibrometer sensor assembly;
detect, via an impulsive noise filter, a signal segment of the vibration data containing an impulsive noise artifact;
replace or modify, via the impulsive noise filter, the detected signal segment with a corrected segment with the impulsive noise artifact removed or lessened to generate a filtered vibration data; and
determine, the defect in the railway track using the filtered vibration data,
wherein the determined defect in the railway track is outputted in a report (digital or physical) for maintenance, repair, or visualization of defects of the railway track.

16. The analysis system of claim 15, wherein the impulsive noise filter is further configured to (i) detect an artificial peak and a fluctuation in a signal segment of the vibration measurements and (ii) smooth and interpolate the signal segment to generate the filtered vibration measurement.

17. The analysis system of claim 15, wherein the processor is further configured to:
apply a transfer function to adjust for differences in the speed of vibration data collection.

18. The analysis system of claim 15, wherein the analysis system further comprises:
an anomaly detector comprising a trained AI model configured to detect broken rails in the railway track based on the filtered vibration data, wherein the detected broken rails are outputted in the report for maintenance, repair, or visualization of defects of the railway track.

19. The analysis system of claim 18, wherein the trained machine learning model was trained using vibration data from one or more mobile defect detections platforms having varied speeds along the railway track, varied defect types, or varied environmental conditions.

20. A non-transitory computer-readable medium having instructions stored thereon, wherein execution of the instructions by a processor causes the processor to perform any of the steps of claim 15.
